(19) United States
(12) Patent Application Publication
(10) Pub. No.: US 2026/0004042 A1
(43) Pub. Date: Jan. 1, 2026

(54) Time-Optimal Placement Path Optimization Method for Surface Mounters

(71) Applicant: Harbin Institute of Technology, Harbin City (CN)

(72) Inventors: Huijun GAO, Harbin (CN); Zhengkai LI, Harbin (CN); Baoqing YIN, Harbin (CN); Hao SUN, Harbin (CN); Xinghu YU, Harbin (CN); Jianbin QIU, Harbin (CN); Weichao SUN, Harbin (CN)

(21) Appl. No.: 18/890,644

(22) Filed: Aug. 26, 2025

(30) Foreign Application Priority Data
Nov. 20, 2023 (CN) 2023115470761

(51) Int. Cl. G06F 30/398; G06F 115/12

(52) U.S. Cl. CPC G06F 30/398; G06F 2115/12

(57) ABSTRACT

The time-optimal placement path optimization method for surface mounters in this invention addresses the issue of excessively long total mounting time and low production efficiency in array-type layout circuit board assembly. This invention divides the placement points on the circuit board into grid rows based on component types and Y-axis coordinates, categorizes the placement points into different grid rows, and performs a global balance search. After identifying the placement points within each grid row that can be mounted simultaneously, it integrates two methods for the initial head-to-point assignment where the “simultaneous placement maximization” method promotes “approximate simultaneous placement” to the greatest extent, and the “progressive search rule” method avoids a purely local greedy search. A general solution framework for placement path optimization is constructed, where based on the initial assignment results, the unassigned remaining placement points are matched using the nearest insertion method, refining and deriving the final optimization result.

### CROSS REFERENCE OF RELATED APPLICATION

This is a non-provisional application that claims priority to Chinese application number 2023115470761, filing date Nov. 20, 2023, the entire contents of each of which are expressly incorporated herein by reference.

### BACKGROUND OF THE PRESENT INVENTION

The invention relates to an optimization method for the placement path of surface mounters, and belongs to the field of electrical technology and electrical engineering.

### DESCRIPTION OF RELATED ARTS

Multi-functional surface mounters are automatic equipment for surface mounting of electronic components and are provided with a high-precision positioning system and high-speed head assemblies, thus being able to efficiently implement SMT operations of electronic components on printed circuit boards (PCBs). The multi-functional surface mounter is formed by a conveying system, a positioning system, head assemblies, a feeding system and a control system. The conveying system conveys PCBs stably, and the positioning system realizes high-accuracy placement of components by means of various sensors and visual systems. The head assemblies are equipped with vacuum nozzles to keep components stable and accurately place the components on PCBs. The feeding system provides components to the head assemblies and automatically adjust the feeding position. The control system performs SMT parameter setting and programming by means of a computer and related software and monitors the SMT process. The multi-functional surface mounter has the features of high precision, high speed, multiple channels, and automatic feeding and detection, thus being important equipment for improving production efficiency, reducing costs and satisfying the requirements of complex circuit boards in electronics manufacturing.

For the sake of a brief description, “electronic component” is collectively referred to as “component” hereinafter, and “pick-and-place” may be abbreviated as “PAP”. As shown in FIG. 1, surface mounters on the present market adopt a gantry type three-dimensional movement platform. Several nozzles that can suck and blow components are uniformly mounted on a carrier of the surface mounter. These nozzles are driven by a motor in the carrier to move up and down along a Z-axis. The carrier of the surface mounter is driven by horizontal and vertical guideways to move in a horizontal plane along an X-axis and a Y-axis. Before the pick-and-place process is implemented, a circuit board will be conveyed to a specified position and firmly fixed by a conveyor belt and clamps attached to the conveyor belt. During the pick-and-place process, feeders fixed to bases will automatically supply and feed components. To-be-picked components are pushed to pickup points at front ends of the feeders to be picked up and used. FIG. 2 illustrates the pick-and-place process of a surface mounter. Because the number of heads on the carrier of each surface mounter is limited and is generally less than the number of placement points, a placement task of a circuit board is generally completed by multiple pick-and-place cycles. The pick-and-place process in each pick-and-place cycle is as follows: the carrier moves to the feeder base first according to a pickup task in this cycle; the heads sequentially move to corresponding component pickup points to pick up components; after all pickup tasks in this pick-and-place cycle are completed, the carrier moves to the circuit board; according to a placement task sequence planned in this cycle, the heads sequentially move to corresponding placement points to perform component placement; and after all placement tasks in this cycle are completed, the pick-and-place process in the next pick-and-place cycle will be implemented.

By optimizing the pick-and-place process of the surface mounter, the SMT time can be greatly shortened. This optimization problem comprises two major sub-problems: “component allocation problem” and “pick-and-place path optimization problem”. “Component allocation” needs to determine the types of components to be placed by heads in each pick-and-place cycle. On this basis, “pick-and-place path optimization” needs to determine the movement path of the carrier in the whole pick-and-place process. During the pick-and-place process, the movement path of the carrier is called the pick-and-place path of the surface mounter. One important objective of pick-and-place process optimization is to minimize the length of the pick-and-place path. According to the starting points and end points of path segments, the pick-and-place path in any one pick-and-place cycle can be divided into four path segments: (1) a pickup path, by which the heads in the current cycle sequentially pick up components, wherein the starting point and end point of the pickup path are both pickup points; (2) a pick-to-place path (also named as slot-to-board path), by which the heads that have picked up components move from the feeder base to the circuit board, wherein the starting point of the pick-to-place path is the last pickup point in the current cycle, and the end point of the pick-to-place path is the first placement point in the current cycle; (3) a placement path, by which the heads in the current cycle sequentially place components, wherein the starting point and end point of the placement path are both placement points; and (4) a place-to-pick path (also named as board-to-slot path), by which the heads that have placed components on the circuit board in the current cycle move from the circuit board to the feeder base, wherein the starting point of the place-to-pick path is the last placement point in the current cycle, and the end point is the first pickup point in the next cycle.

From the view of signal integrity and aesthetics of spatial layout, the array component layout shown in FIG. 3 is used for the design of a large proportion of circuit boards. The array design of LED lamps, resistors, capacitors and other components is especially common for circuit boards provided with LED lamps. Beam-type carriers are superior to some extent in surface mounting of “circuit boards adopting the array-type layout”, the head assemblies are uniformly distributed in the X-direction, and the length of the movement path of the carrier can be decreased by reasonable assignment of placement points in each pick-and-place cycle. The interval between adjacent heads of the beam-type carrier is twice the interval between adjacent feeder slots, such that simultaneous pickups can be performed to equivalently reduce the number of pickups, and this is an important optimization objective during component allocation. In addition, if placement points corresponding to two heads have the same Y-coordinate and the interval between the two placement points is the same as the interval between the two adjacent heads when placement is performed in one pick-and-place cycle, simultaneous placement can be performed. Because the placement points are arranged randomly as required in design of the circuit board, the probability of realizing simultaneous placement is extremely low. Although it is less likely to realize strict simultaneous placement, approximate simultaneous placement is often available. Wherein, “approximate simultaneous placement” means that for two heads performing placement successively, the movement distance of the carrier for two placements is extremely small, such as 2 mm. The significance of realizing approximate simultaneous placement is to effectively shorten the total SMT movement time, which can be easily understood by means of an analysis on the movement of a motor.

The movement curve of the motor is a generally planned into an S-shaped or T-shaped accelerating curve, such that the time required for the motor to move along a fixed path can be calculated. Table 1 and Table 2 respectively show the time required for the motor to move by 100 mm and 200 mm respectively. It can be seen from Table 1 and Table 2 that the movement times are significantly different although the total lengths of the movement paths are identical. The total movement time will be decreased with the increase in the difference between the two paths. This is because the motor can accelerate sufficiently to fulfill a high average movement speed in case of a long movement path, so the movement time is shortened accordingly. This phenomenon is more likely to occur by realizing more approximately simultaneous placement, so as to shorten the total movement time.

TABLE 1
Movement time for 100 mm by two segments

| Length of first | Length of second | Movement |
|---|---|---|
| path segment | path segment | time (s) |
| 50 | 50 | 0.1987 |
| 60 | 40 | 0.1977 |
| 70 | 30 | 0.1946 |
| 80 | 20 | 0.1885 |
| 90 | 10 | 0.1778 |
| 95 | 5 | 0.1684 |

TABLE 2
Movement time for 200 mm by two segments

| Length of first | Length of second | Movement |
|---|---|---|
| path segment | path segment | time (s) |
| 100 | 100 | 0.2811 |
| 120 | 80 | 0.2796 |
| 140 | 60 | 0.2754 |
| 160 | 40 | 0.2679 |
| 180 | 20 | 0.2543 |
| 190 | 10 | 0.2422 |

Existing studies show the following major defects: existing commercial software, when used for placement path optimization, only focuses on the minimization of the path length and neglects the importance of approximate simultaneous placement in shortening the SMT movement time, does not design specific algorithms that adapt to the array distribution of placement points and promote the realization of more approximate simultaneous placements, so the situation where one left placement head places components that are relatively to the right among the to-be-placed components may occur, which is unable to balance between local greedy search and global optimization, thus leading to an excessively long total SMT movement time and low SMT production efficiency.

### SUMMARY OF THE PRESENT INVENTION

To solve the problems of an excessively long total SMT movement time and low SMT production efficiency during assembly of circuit boards adopting an array-type layout, the invention provides a time-optimal placement path optimization method for surface mounters

The time-optimal placement path optimization method for surface mounters provided by the invention is suitable assembling circuit boards adopting an array placement point arrangement and comprises: invoking a grid row grouping algorithm to classify placement points corresponding to a same type of components and having approximately the same Y-coordinate on a circuit board into one grid row; invoking a placement point assignment algorithm based on a progressive search rule to complete assignment of placement points corresponding to heads one by one, and constraining a search range of the assigned placement points to avoid a situation where one left placement head places components that are relatively to the right among the to-be-placed components, obtaining an initial placement point assignment result;
invoking a simultaneous placement point grouping algorithm to classify placement points, intervals between X-coordinates of which are approximately the same as intervals between the heads, in the grid rows into one simultaneous placement group; invoking a placement point assignment algorithm based on a simultaneous placement-maximized assignment rule to assign the placement points in the grid rows according to simultaneous placement groups to realize more minimum-distance simultaneous placement paths to decrease the overall length of short-distance movement paths so as to shorten the total time of a SMT movement process; assigning placement points that fail to form a simultaneous placement group in the grid rows according to the progressive search rule to obtain an initial placement point assignment result; and
comparing the initial placement point assignment results obtained by the two algorithms, selecting the one with a shorter total movement time, and allocating the placement points along the Y-axis between grid row; based on a placement point assignment result, completing placement point assignment of remaining heads by means of a nearest insertion method, and obtaining a placement sequence of the heads by means of a farthest insertion method to obtain a placement path optimization result.

The invention has the following beneficial effects: first, the invention divides the placement points on the circuit board into grid rows based on component types and Y-coordinates of the placement points; this classification assigns placement points to different grid rows, enabling a balanced global search and providing a prerequisite for maximizing simultaneous placement; placement points that can form “approximate simultaneous placement” in the grid rows are recognized, such that a strategy for dividing placement points on array-type layout circuit boards is provided; subsequently, it integrates two methods for the initial head-to-point assignment where the “simultaneous placement maximization” method promotes “approximate simultaneous placement” to the greatest extent, and the “progressive search rule” method avoids a purely local greedy search; a general solution framework for placement path optimization is constructed, where based on the initial assignment results, the unassigned remaining placement points are matched using the nearest insertion method, refining and deriving the final optimization result; this method can significantly reduce the movement time of the placement head during the actual placement process, thereby effectively improving circuit board assembly efficiency. Experiments have shown that the method provided by this invention can substantially increase the production efficiency of surface mounters, with a maximum efficiency improvement of 21.83% compared to commercial software.

### BRIEF DESCRIPTION OF THE DRAWINGS

FIG. 1 is a schematic diagram of assembling a circuit board adopting a hybrid layout by a surface mounter;

FIG. 2 is a flow diagram of assembling a circuit board by a surface mounter;

FIG. 3 is a schematic diagram of assembling a circuit board adopting an array layout by a surface mounter;

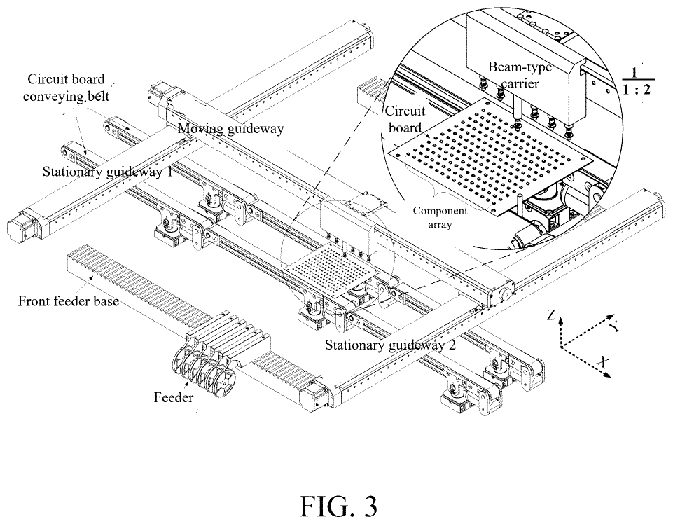

FIG. 4 is a flow diagram of a time-optimal optimization method for the placement path of surface mounters in a case where the time-optimal optimization method is used for assembling a circuit board adopting an array layout;

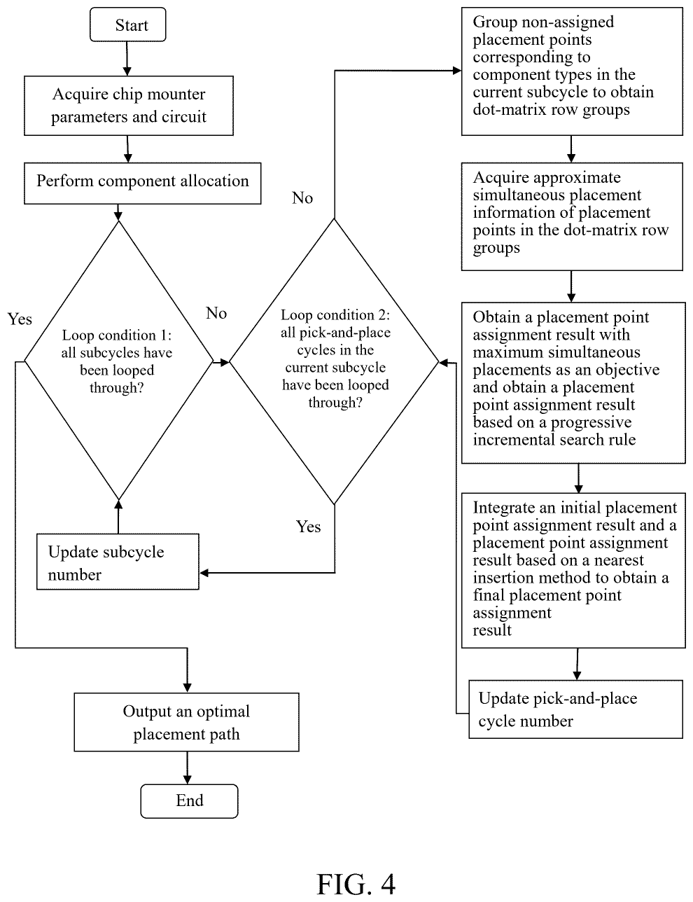

FIG. 5 is a schematic diagram of a placement path for assembling a circuit board adopting an array layout obtained by the invention according to one exemplary application;

FIG. 6 is a schematic diagram of a placement path for assembling a circuit board adopting an array layout obtained by commercial software according to one exemplary application;

FIG. 7 is a schematic diagram of a placement path for assembling a circuit board adopting a hybrid layout obtained by the invention according to one exemplary application;

FIG. 8 is a schematic diagram of a placement path for assembling a circuit board adopting a hybrid layout obtained by commercial software according to one exemplary application.

### DETAILED DESCRIPTION OF THE PREFERRED EMBODIMENT

The technical solutions in the embodiments of the invention will be clearly and completely described below in conjunction with accompanying drawings of the embodiments of the invention. Obviously, the embodiments in the following description are merely illustrative ones, and are not all possible ones of the invention. All other embodiments obtained by those ordinarily skilled in the art based on the following ones without creative labor should also fall within the protection scope of the invention. It should be noted that embodiments in the invention and the features in the embodiments can be combined without conflicts. The invention is further described below in conjunction with accompanying drawings and specific embodiments, but the following description is not intended to limit the invention.

This embodiment provides a time-optimal placement path optimization method for surface mounters, which is suitable for assembling circuit boards adopting an array placement point layout and comprises:
invoking a grid row grouping algorithm to classify placement points corresponding to a same type of components and having approximately the same Y-coordinate on a circuit board into one grid row; invoking a placement point assignment algorithm based on a progressive search rule to complete assignment of placement points corresponding to heads one by one, and constraining a search range of the assigned placement points to avoid a situation where one left placement head places components that are relatively to the right among the to-be-placed components, obtaining an initial placement point assignment result;
invoking a simultaneous placement point grouping algorithm to classify placement points, intervals between X-coordinates of which are approximately the same as intervals between the heads, in the grid rows into one simultaneous placement group;
invoking a placement point assignment algorithm based on a simultaneous placement-maximized assignment rule to assign the placement points in the grid rows according to simultaneous placement groups to realize more minimum-distance simultaneous placement paths to decrease the overall length of short-distance movement paths so as to shorten the total time of a SMT movement process; assigning placement points that fail to form a simultaneous placement group in the grid rows according to the progressive search rule to obtain an initial placement point assignment result; and
comparing the initial placement point assignment results obtained by the two algorithms, selecting the one with a shorter total movement time, and allocating the placement points along the Y-axis between grid row; based on a placement point assignment result, completing placement point assignment of remaining heads by means of a nearest insertion method, and obtaining a placement sequence of the heads by means of a farthest insertion method to obtain a placement path optimization result.

In this embodiment, the time-optimal placement path optimization method for surface mounters specifically comprises:
Step 1, acquiring parameters of a surface mounter and production data of a circuit board;
Step 2, looping through all subcycles, and sequentially invoking, in each subcycle, the following algorithms to obtain a placement path optimization result, specifically:
Step 21, initializing parameters of the subcycles and pick-and-place cycles;
Step 22, looping through all the subcycles, and performing Steps 23-27 in each pick-and-place cycle of each subcycle;
Step 23, invoking a grid row grouping algorithm to classify placement points corresponding to the same type of components and having approximately the same Y-coordinate on the circuit board into one grid row;
Step 24, invoking a simultaneous placement point grouping algorithm to classify placement points, intervals between X-coordinates of which are approximately the same as intervals between heads, in the grid rows into one simultaneous placement group;
Step 25, invoking an initial placement point assignment algorithm to assign placement points in the grid rows:
on the one hand, invoking a placement point assignment algorithm based on a progressive search rule to complete assignment of placement point corresponding to the heads, and constraining a search range of the assigned placement points to avoid a situation where the heads on the left deviate from components on the right, thus obtaining an initial placement point assignment result; on the other hand, invoking a placement point assignment algorithm based on a simultaneous placement-maximized assignment rule to assign the placement points in the grid rows according to simultaneous placement groups to realize more minimum-distance simultaneous placement paths to decrease the overall length of short-distance movement paths so as to shorten the total time of a SMT movement process; assigning placement points that fail to form a simultaneous placement group in the grid rows according to the progressive search rule to obtain an initial placement point assignment result;
wherein, the progressive search rule carries out placement point assignment based on grid rows, and the progressivity of the progressive search rule is embodied in the constraint on the assignment process of placement points in the grid rows to keep the rhythm of the assignment process so as to overcome the shortsightedness of the traditional greedy search rule, and the situation where the heads on the left deviate from the components on the right is avoided; meanwhile, the placement-maximized assignment rule carries out placement point assignment according to simultaneous placement groups, components are looped through according to the types of to-be-assigned components corresponding to the heads, and whether simultaneous placement corresponding to the grouped placement points can be realized during the looping process, and an assignment result realizing the most simultaneous placements is selected and reserved by comparison; in a case where the same number of simultaneous placements are realized, the lengths of movement paths are further compared; placement points that fail to form a simultaneous placement group in the grid rows are still assigned according to the progressive search rule; because the movement speed within a short distance is low during the accelerated movement process of a motor and the movement time will be increased obviously with the increase of the movement path, the realization of more extremely-short simultaneous placement paths can decrease the length of the movement path on the whole so as to shorten the total time of the SMT movement process, thus greatly improving SMT production efficiency; the number of placement points to be assigned by the two methods is the same, so assignment results obtained by the two methods can be compared; by comparing the initial placement point assignment results obtained by the two methods, the initial placement point assignment result with a relatively short total movement time is selected;
Step 26, performing matching of the grid rows in a Y-direction according to the initial placement point assignment result selected in Step 25, wherein because the Y-coordinates of the placement points in the grid row are approximately the same, only a total movement time in an X-direction is calculated finally in Step 5 and used as a relatively better indicator;
Step 27, based on a placement point assignment result, completing placement point assignment of remaining heads by means of a nearest insertion method, and obtaining a placement sequence of the heads by means of a farthest insertion method; and
Step 28, outputting a placement path optimization result.

In this embodiment, a method for acquiring the parameters of the surface mounter and the production data of the circuit board comprises:
Step 11, importing the parameters of the surface mounter: the total number H of heads, index numbers hϵ[1, . . . , H] of the heads in an ascending order in the X-direction, intervals HDI between the heads, a movement speed VX of the surface mounter in the X-direction, and a movement speed VY of the surface mounter in the Y-direction; and
Step 12, acquiring the production data of the circuit board: component groups CPgin the pick-and-place cycles, the number SubcycleCPg of subcycles of the pick-and-place cycles, a first cycle floorCycle and a last cycle ceilCycle of each subycle, an X-coordinate CpTX and a Y-coordinate CpTY of the placement point corresponding to each component, serial numbers CpTNo of the placement points, the number numCpT of types of components to be placed on the circuit board, and the number numPTinCpT of placement points corresponding to each type of components, wherein the pick-and-place cycles corresponding to the same component groups form one subcycle, that is, in this embodiment, the pick-and-place cycles corresponding to the same component group are referred to as one subcycle.

In this embodiment, a method for sequentially invoking, in each subcycle, the following algorithms to obtain a placement path optimization result comprises:
Step 21, initializing parameters, wherein the parameters include the total number TotalCyc=sum(SubcycleCPg) of pick-and-place cycles, the number numCPg=numel(SubcycleCPg) of subcycles, an assignment result PA=zeros(TotalCyc, H) of placement points corresponding to heads, the thickness boundaryLayer=2 of a boundary layer of placement points classified into the same grid row, an array STcounter=cell(numCpT, 1) recording information about the number of points, capable of participating in simultaneous placement, in the grid rows corresponding to different types of components, and the number CPg1stCyc=floorCycle of the first pick-and-place cycle in each subcycle;
wherein, a numel function is used for acquiring the number of elements in an array, for example, numel([1 2 3 4])=4; a zero function is used for initializing an all-0 matrix, for example, zeros(2,2)=[0, 0; 0, 0]; a sum function is used for calculating the sum of values of all elements in an array, for example, sum([1, 2, 3])=6; a cell function is used for initializing a cell array, for example, cell(1,2)={{ }, { }};
Step 22, looping through all the subcycles:
Step 221, initializing a component group count variable cntCPg=1;
Step 222, determining whether cntCPg<numCPg; if so, initializing the serial number of a pick-and-place cycle that has completed placement point assignment, and performing Step 223; otherwise, performing Step 28;
Step 223, determining whether cyclast<ceilCycle(cntCPg); if so, performing Step 234; otherwise, updating cntCPg=cntCPg+1, and returning to Step 222;
Step 224, updating a temporary variable CpTX0=CpTX of CpTX, updating a temporary variable CpTY0=CpTY of CpTY, updating a temporary variableCpNo0=CpNo of CpNo, updating a component group temporary variable tmpCPg=CPg(cntCPg,:), acquiring index positions idxSame=find(tmpCPg==0) of non-assigned components in a component group, removing the non-assigned components from the component group tmpCPg(idxSame)=[ ], and saving the types of components in the component group in an array CPTinCPg;
wherein, a find function is used for searching for element indexes satisfying a condition in an array, for example, find([1 2 0 3 5]==0)=3;
Step 225, determining whether tmpCPg is not empty; if so, performing Step 226; otherwise, performing Step 227;
Step 226, updating CPTinCPg=[CPTinCPgtmpCPg(1)], acquiring indexes idxSame=find(tmpCPg==tmpCPg(1)) the same as tmpCPg(1), removing components tmpCPg(idxSame) corresponding to the indexes from the component group, and returning to Step 225;
Step 227, updating numCPTinCPg=numel(CPTinCPg), the types CPT_JL-CPTinCPg of components assigned according to the progressive search rule, and the number numCPT_JL-numCPTinCPg of components in the component group, initializing an array Head2CPT=cell(numCpT,1) of head numbers corresponding to each type of components, initializing an array numHd2CpTs=zeros(numCpT,1) of the number of heads corresponding to each type of components, and initializing a component type count variable cntCpT=1;
Step 228, determining whether cntCpT<numCPTinCPg; if so, performing Step 229; otherwise, performing Step 231; and
Step 229, updating a component type index idxCpT=CPTinCPg(cntCpT), acquiring Head2CPT0{idxCpT,1}=find(CPg(cntCPg,:)==idxCpT), updating numHd2CpTs(idxCpT)=numel(Head2CPT0{idxCpT,1}), updating Head2CPT{idxCpT,1}=Head2CPT0{idxCpT,1}(numHd2CpTs(idxCpT):−1:1), updatingcntCpT=cntCpT+1, and returning to Step 228;
wherein, Steps224-229 are performed mainly for data preprocessing for the generation of the grid rows and providing information required for the division of the grid rows, such as the types of components in the current component group, the number of each type of components, and the number of heads corresponding to each type of components;
Step 231, according to pTX0, CpTY0, CpNo0, boundaryLayer, CPT_JL, numCPT_JL and numHd2CpTs, invoking the grid row grouping algorithm in Step 3 to obtain PTAGroup, LengthPTAG, PtArrayX, PtArrayN and StorePTAG_R;
wherein, PTAGroup is a grid row group; LengthPTAG is a length storage array in the grid row group; a grid row placement point information recoding array PtArrayX records X-coordinates of the placement points in the grid rows; a grid row placement point information recoding array PtArrayN records the serial numbers of the placement points in the grid rows; StorePTAG_R is a count index of the grid rows from right to left;
Step 232, initializing tmpCPg=ones(1, H), acquiring indexes idx0=find(CPg(cntCPg,:)==0) of heads, to which components are not allocated, in the component group, updating tmpCPg(idx0)=tmpCPg(idx0)*0, initializing grid row group usage information usedPTAGinfo=cell(2,1) and all available heads usedHDs in the current component group, and initializing the component type count variable cntCpT=1, wherein a ones function is used for generating an all-1 matrix, for example, ones(1, 2)=[1, 1];
Step 233, determining whether cntCpT<numCPT_JL; if so, performing Step 234; otherwise, performing Step 235;
Step 234, acquiring the component type index idxCpT=CPT_JL(cntCpT), updating tmpCPg(Head2CPT{idxCpT,1})=tmpCPg(Head2CPT{idxCpT,1})*cntCpT, updating usedPTAGinfo{1,1}=[usedPTAGinfo{1,1} [idxCpT; 1]], updating usedPTAGinfo{2, 1}{cntCpT}=StorePTAG_R{idxCpT}{1}, updating usedHDs=[usedHDs Head2CPT{idxCpT,1}], updating cntCpT=cntCpT+1, and returning to Step 233;
Step 235, the heads in a descending sorting order usedHDs=sort(usedHDs,‘descend’), acquiring the number numHDs=numel(usedHDs) of used heads, initializing a minimum number mincyc=SubcycleCPg(cntCPg)−(CPg1stCyc(cntCPg)−floorCycle(cntCPg)) of completion cycles of the grid rows, and initializingcntCpT=1, wherein a sort function is used for sorting elements in an array according to values of the elements and returning an index sequence obtained after sorting, and “descend” refers to sorting in a descending order, for example, sort([1 2 5 3])=[3 4 2 1];
Step 236, determining whether cntCpT<numCPT_JL; if so, performing Step 237; otherwise, performing Step 238;
Step 237, acquiring the component type index idxCpT=CPT_JL(cntCpT), acquiring the lengthnumPTinPTA4=LengthPTAG{idxCpT,1}(1) of the grid rows, acquiring the number numHd=numHd2CpTs(idxCpT) of heads corresponding to current components, acquiring the minimum number mincyc1=floor(numPTinPTA4/numHd) of completion cycles of the grid rows corresponding to the current components, and determining whether mincyc>mincyc1; if so, updating mincyc=mincyc1; otherwise, updating cntCpT=cntCpT+1, and returning to Step 236;
Step 238, initializing a “placement point-head pair” information storage array SeqPTAX=cell(mincyc, H) and a corresponding temporary variable SeqPTAX0=SeqPTAX;
initializing a minimum time TMin_PTAG=inf of grid row-based assignment; acquiring indexes idx0s=find(CPT_JL==0) of elements 0 in CPT_JL, and deleting the indexes CPT_JL(idx0s)=[ ]; sorting the numbers of heads used for different types of components in the current component group in a descending order [˜,idxsort]=sort(numHd2CpTs(CPT_JL), ‘descend’), CPT_JL=CPT_JL(idxsort);
initializing the number numPTA=zeros(1,numCPT_JL) of grid rows in the first grid row group of each type of components, wherein numCPT_JL=numel(CPT_JL);
initializing the component type count variable cntCpT=1; and
Step 239, determining whether cntCpT<numCPT_JL; if so, acquiring the component type index idxCpT=CPT_JL(cntCpT), initializingSTcounter{idxCpT,1}{1,1}=zeros(1,LengthPTAG{idxCpT,1}(1)), and initializingSTcounter{idxCpT,1}{1,2}=cell(1,LengthPTAG{idxCpT,1}(1)), wherein
STcounter is used for counting simultaneous placements realized by points in an ideal grid row corresponding to the current component group LengthPTAG; updating numPTA(cntCpT)=size(PTAGroup{idxCpT}{1},2), updating cntCpT=cntCpT+1, and returning to Step 239; otherwise, performing Step 24;
Step 24, according to numPTA, PtArrayX,PTAGroup, LengthPTAG, numHd2CpTs, Head2CPT, STcounter, boundaryLayer, CPT_JL and numCPT_JL, invoking the simultaneous placement point grouping algorithm in Step 4 to obtain an approximate simultaneous placement information storage array STMatchInfo and the array STcounter recording information about the number of points, capable of participating in simultaneous placement, in the grid rows corresponding to different types of components;
Step 25, with the realization of maximum simultaneous placements as a main objective, assigning the placement points in the grid rows, comprising:
Step 251, initializing a flag flag1stPT=1 indicting the presence of assigned points, initializing a predicted placement time of each cycle TinCycs_Mix=zeros(1,mincyc), initializing a temporary variable UPTAGI_Mix=usedPTAGinfo of usedPTAGinfo, initializing a temporaryvariableSeqPTA_Mix=SeqPTAX of SeqPTAX, and initializing a cycle count variable cntmc=1;
Step 252, determining whether cntmc<=mincyc; if so, simultaneously performing Step 253 and Step 254; otherwise, performing Step 258;
Step 253, initializing a no-simultaneous placement storage array NoSTHDs=[ ], ST_UHD0==NOSTHDs, usedPTAGinfo=UPTAGI_Mix, SeqPTA=SeqPTA_Mix, and according to cntmc, usedPTAGinfo, SeqPTA, usedHDs, tmpCPg, PtArrayX, STcounter, STMatchInfo, mincyc, ST_UHD0,PTAGroup and flag1stPT, invoking the placement point assignment algorithm based on the progressive search rule in Step 5 to obtain an initial assignment result of a placement point-head pair: grid row group usage information usedPTAGinfo, an assignment condition SeqPTA of the current “placement point-head pair”, and a movement time TinCYC in the current cycle; updating usedPTAGinfo2=usedPTAGinfo, updatingSeqPTA2=SeqPTA, updating T_PTAinCYC=TinCYC, and performing Step 256;
Step 254, usedPTAGinfo=UPTAGI_Mix, SeqPTA=SeqPTA_MixmnumCPTinCPg=numCPT_JL; according to cntmc, usedPTAGinfo, SeqPTA, usedHDs, tmpCPg, PtArrayX, STcounter, STMatchInfo, numCPTinCPg and PTAGroup, invoking the placement point assignment algorithm based on the simultaneous placement-maximized assignment rule in Step 6 to obtain an initial assignment result of the placement point-head pair: grid row group usage information usedPTAGinfo, the assignment condition SeqPTA of the current “placement point-head pair” and the indexes ST_UHD of heads capable of realizing simultaneous placement; performing Step 255;
Step 255, updating ST_UHD0=ST_UHD; according to cntmc, usedPTAGinfo, SeqPTA, usedHDs, tmpCPg, PtArrayX, STcounter, STMatchInfo, mincyc, ST_UHD0, PTAGroup and flag1stPT, invoking the placement point assignment algorithm based on the progressive search rule in Step 5 to obtain an initial assignment result of a placement point-head pair: grid row group usage information usedPTAGinfo, the assignment condition SeqPTA of the current “placement point-head pair” and the movement time TinCYC in the current cycle; updating usedPTAGinfo0_1=usedPTAGinfo, updating SeqPTA0_1=SeqPTA, updating T_PTAinCYC0_1=TinCYC, and performing Step 256;
Step 256, determining whether T_PTAinCYC<T_PTAinCYC0_1; if so, updating SeqPTA_Mix=SeqPTA2, updating UPTAGI_Mix=usedPTAGinfo2, and updating TinCycs_Mix (cntmc)=T_PTAinCYC; otherwise, updating SeqPTA_Mix=SeqPTA0_1, updating UPTAGI_Mix=usedPTAGinfo0_1, and updating TinCycs_Mix (cntmc)=T_PTAinCYC0_1;
Step 257, updating cntmc=cntmc+1, and returning to Step 252;
Step 258, obtaining a total cycle time TSum_Mix=sum(TinCycs_Mix); and
Step 259, determining whether TMin_PTAG>TSum_Mix; if so, updating TMin_PTAG=TSum_Mix, and updating SeqPTAX=SeqPTA_Mix;
Step 26, performing matching of the grid rows in the Y-direction:
Step 261, acquiring the number numUsedPTA=min([numPTAof used grid rows, floor(SubcycleCPg(cntCPg)/mincyc)]), initializing a grid row sequence SeqPTAY=zeros(numUsedPTA,numCPT_JL) in the Y-direction, and initializing the component type count variable cntCpT=1, wherein a min function is used for acquiring a minimum value of elements in an array;
Step 262, determining whether cntCpT<numCPT_JL; if so, updating SeqPTAY(:,cntCpT)=1:numUsedPTA, updating cntCpT=cntCpT+1, and returning to Step 262;
Step 263, initializing a temporary variable preOCP=PA of PA, and initializingcntUPTA=1;
Step 264, determining whether cntUPTA<numUsedPTA; if so, performing Step 256; otherwise, performing Step 27;
Step 265, determining whether mincyc is not 0; if so, acquiring a first cyclecycfirst=CPg1stCyc(cntCPg)+(cntUPTA−1)*mincyc, acquiring a last cyclecyclast=min([CPg1stCyc(cntCPg)+cntUPTA*mincyc−1, ceilCycle(cntCPg)]), and initializing a cycle count variable cntcyc=cycfirst; otherwise, updating cntUPTA=cntUPTA+1, and returning to Step 264;
Step 266, determining whether cntcyc<cyclast; if so, initializing the component type count variable cntCpT=1, and performing Step 267; otherwise, updating cntUPTA=cntUPTA+1, and returning to Step 264;
Step 267, determining whether cntCpT<numCPT_JL; if so, acquiring idxCpT=CPT_JL(cntCpT), initializing a head count variable cntHd=1, and performing Step 268; otherwise, updating cntcyc=cntcyc+1, and returning to Step 266;
Step 268, determining whethercntHd<numHd2CpTs(idxCpT); if so, acquiring a head index idxHd=Head2CPT{idxCpT,1}(cntHd), and acquiring corresponding cycles in SeqPTAX; otherwise, updating cntCpT=cntCpT+1, and returning to Step 267; and
Step 269, determining whether SeqPTAX{idxcyc,idxHd} is empty; if so, acquiringidxPTinArray=SeqPTAX{idxcyc,idxHd}(3), acquiringidxPTAG=SeqPTAX{idxcyc,idxHd}(2), acquiring cntPTA=SeqPTAY(cntUPTA,cntCpT), acquiringidxPTA=PTAGroup{idxCpT}{idxPTAG}(1,cntPTA), and updating preOCP(cntcyc,idxHd)=PtArrayN{idxCpT,idxPTA}(idxPTinArray); updating cntHd=cntHd+1, and returning to Step 268;
Step 27, performing Step 7, matching remaining non-assigned placement points by means of the nearest insertion method, updating CPg1stCyc(cntCPg)=cyclast+1, updating PA=BestOCP, updating numPTinCpT=BestnumPT, and returning to Step 223; and
Step 28, outputting a placement path optimization result.

In this embodiment, the grid row grouping algorithm comprises:
Step 31, initializing parameters, wherein the parameters include: grid row placement point information recording arrays PtArrayX, PtArrayY and PtArrayN, grid row groups PTAGroup, length storage arrays LengthPTAG in the grid row groups, an array L0ArrayX of the distance from each point in each grid row to the first point, count indexes StorePTAG_R of the grid rows from right to left, and the number numPTAGinCpt of grid rows corresponding to each type of components, wherein the length storage arrays are in one-to-one correspondence with the grid row groups;
the grid row placement point information recording array PtArrayY is used for recording Y-coordinates of the placement points in the grid rows;
the grid row groups PTAGroup are used for storing grouping information of different dot matrix rows corresponding to different components;
Step 32, initializing the component type count variable cntCpT=1;
Step 33, determining whether cntCpT<numCPT_JL; if so, performing Step 34; otherwise, performing Step 36;
Step 34, updating a current component type index idxCpT=CPT_JL(cntCpT), and updating the thickness boundaryLayer of the boundary layer;
Step 35, classifying current component placement points into differentgrid rows;
Step 351, initializing a grid row group temporary variable PTAGroup0{idxCpT,1}=[ ]; initializing the lengthstorage array lenPTAG; assigning X-coordinates, Y-coordinates and numbers of the placement points CpTY1=CpTY0, CpTX1=CpTX0 and CpNo1=CpNo0; assigning the grid row placement point information recording arrays PtArrayX_1=PtArrayX, PtArrayY_1=PtArrayY and PtArrayN_1=PtArrayN; initializing a grid row group count variable numPTAG=0; initializing a grid row count variable cntPtArray=0;
Step 352, determining whether CpTY1{idxCpT} is not empty; if so, performing Step 353; otherwise, performing Step 357;
Step 353, updating cntPtArray=cntPtArray+1; acquiring indexes idxSameArray=find(abs(CpTY1{idxCpT}−CpTY1{idxCpT}(1))<boundaryLayer) of placement points, the distance from Y-coordinates of which to CpTY1{idxCpT}(1) is less than the thickness of the boundary layer, corresponding to the current components; updating the placement points satisfying the condition into the grid row placement point information recording arrays PtArrayX_1{idxCpT,cntPtArray}=CpTX1{idxCpT}(idxSameArray), PtArrayY_1{idxCpT,cntPtArray}=CpTY1{idxCpT}(idxSameArray) and PtArrayN_1{idxCpT,cntPtArray}=CpNo1{idxCpT}(idxSameArray);
Step 354, sorting grid row placement point information according to the Y-coordinates, wherein [PtArrayX_1{idxCpT,cntPtArray},idxPAXsort]=sort(PtArrayX_1{idxCpT,cntPtArray}), idxPAXsort is placement point index information obtained after sorting; PtArrayX_1{idxCpT,cntPtArray}=PtArrayX_1{idxCpT,cntPtArray}(idxPAXsort), PtArrayY_1{idxCpT,cntPtArray}=PtArrayY_1{idxCpT,cntPtArray}(idxPAXsort), PtArrayN_1{idxCpT,cntPtArray}=PtArrayN_1{idxCpT,cntPtArray}(idxPAXsort); removing extracted placement points to avoid secondary assignment; CpTX1{idxCpT}(idxSameArray)=[ ], CpTY1{idxCpT}(idxSameArray)=[ ], CpNo1{idxCpT}(idxSameArray)=[ ]; calculating lengthsnumPTinAG=numel(PtArrayX_1{idxCpT,cntPtArray}) of extracted grid rows;
Step 355, determining whether numPTAG>0; if so, performing Step 36; otherwise, performing Step 356;
Step 356, updatingnumPTAG=1; calculating the distance from each point in the grid row to the first point L0ArrayX{idxCpT,cntPtArray}=PtArrayX_1{idxCpT,cntPtArray}−PtArrayX_1{idxCpT,cntPtArray}(1); recording the lengthlenPTAG=[lenPTAGnumPTinAG] of grid rows in the current grid row group; updating the grid row group informationPTAGroup0{idxCpT,1}{numPTAG}=[cntPtArray;sum(PtArrayY_1{idxCpT, cntPtArray})/numPTinAG]; returning to Step 352;
Step 357, determining whether max (lenPTAG)>=numHd2CpTs(idxCpT); if so, performing Step 37; otherwise, performing Step 358; and
Step 358, increasing the thickness of the boundary layer boundaryLayer=boundaryLayer+2 to ensure that the length of the grid rows corresponding to the components at least satisfies the requirement of one cycle; returning to Step 351;
Step 36, looping through grid row groups that have completed assignment, and determining whether the currentgrid row belongs to an existing grid row group:
Step 361, initializing the grid row group count variable cntPTAG=1;
Step 362, determining whether cntPTAG<numPTAG; if so, performing Step 363; otherwise, returning to Step 352;
Step 363, acquiring an index idxPTA=PTAGroup0{idxCpT,1}{cntPTAG}(1) of the first grid row in the (cntPTAG)^{th} group;
Step 364, determining whether lenPTAG(cntPTAG)==numPTinAG; if so, performing Step 365; otherwise, performing Step 368;
Step 365, determining whether the X-axis coordinates of the first placement points in the currently extracted grid row and in historically stored grid rows are close abs(PtArrayX_1{idxCpT,cntPtArray}(1)−PtArrayX_1{idxCpT,idxPTA}(1))<boundaryLayer; if so, performing Step 366; otherwise, performing Step 368, wherein an abs function is used for acquiring an absolute value of an element;
Step 366, calculating the distance from each point in the grid row to the first point L0ArrayX{idxCpT,cntPtArray}=PtArrayX_1{idxCpT,cntPtArray}−PtArrayX_1{idxCpT,cntPtArray}(1);determining whether sum(abs(L0ArrayX{idxCpT,cntPtArray}−L0ArrayX{idxCpT,idxPTA}))/numPTinAG<boundaryLayer; if so, performing Step 367; otherwise, performing Step 368;
Step 367, updating the grid row group information PTAGroup0{idxCpT,1}{cntPTAG}=[PTAGroup0{idxCpT,1}{cntPTAG}[cntPtArray;sum(PtArrayY_1 {idxCpT,cntPtArray})/numPTinAG]], and returning to Step 352;
Step 368, determining whether cntPTAG==numPTAG; if so, performing Step 369; otherwise, updating cntPTAG=cntPTAG+1, and returning to Step 361; and
Step 369, updating numPTAG=numPTAG+1, updating lenPTAG=[lenPTAGnumPTinAG], updating PTAGroup0{idxCpT,1}{numPTAG}=[cntPtArray;sum(PtArrayY_1{idxCpT,cntPtArray})/numPTinAG], and returning to Step 352;
Step 37, updating PtArrayX=PtArrayX_1, updating PtArrayY=PtArrayY_1, updating PtArrayN=PtArrayN_1, updating the grid row lengthsLengthPTAG{idxCpT,1}=lenPTAG in the grid row groups corresponding to the current components, updating cntCpT=cntCpT+1, and returning to Step 33;
Step 38, performing postprocessing on grid row data:
Step 381, initializing the component type count variable cntCpT=1;
Step 382, determining whether cntCpT<numCPT_JL; if so, performing Step 383; otherwise, performing Step 39;
Step 383, updating the component type index idxCpT=CPT_JL(cntCpT); sorting the grid row lengths corresponding to the current components in a descending order to ensure the assignment priority of long dot matrix rows [LengthPTAG{idxCpT,1},idxLSort]=sort(LengthPTAG{idxCpT,1},‘descend’); acquiring the number numPTAGinCpt (idxCpT)=numel(idxLSort) of grid row groups corresponding to the current components;
Step 384, initializing the grid row group count variablecntPTAGinCPT=1;
Step 385, determining whether cntPTAGinCPT<numPTAGinCpt (idxCpT); if so, performing Step 386; otherwise, updating cntCpT=cntCpT+1; returning to Step 382;
Step 386, updating the grid row group information according to a grid row length sorting resultPTAGroup{idxCpT,1}{cntPTAGinCPT}=PTAGroup0{idxCpT,1}{idxLSort (cntPT AGinCPT)}; acquiring the number numPTinPTA=LengthPTAG{idxCpT,1}(cntPTAGinCPT) of placement points in the longest grid row; updating StorePTAG_R{idxCpT}{cntPTAGinCPT}=numPTinPTA:−1:1; updating cntPTAGinCPT=cntPTAGinCPT+1; returning to Step 385, wherein num:−1:1 indicates the generation of a sequence from num to 1 in a descending order; and
Step 39, returning PTAGroup, LengthPTAG, PtArrayX, PtArrayN and StorePTAG_R, and returning to Step 232.

In this embodiment, the simultaneous placement point grouping algorithm comprises:
Step 41, initializing parameters, wherein the parameters include: an array STYMem=[ ] storing information of components with the same Y-coordinate, the number numSTM=0 of combinations in STYMem, and STMatchInfo=cell(1,3);
Step 42, looping through all component types, and performing assignment with a current component as a main component: the type of the component searched out is taken as a reference component type, and the component is called “main component”;
Step 421, initializing the component type count variable cntCpT=1, and initializing a longest grid row index of each type of components idxPTAGinCPT=1;
Step 422, determining whether cntCpT<numCPT_JL; if so, performing Step 43; otherwise, performing Step 49;
Step 43, looping through grid rows in the current grid row group:
Step 431, initializing the grid row count variable cntPTA=1;
Step 432, determining whether cntPTA<numPTA(cntCpT); if so, performing Step 433; otherwise, updating cntCpT=cntCpT+1, and returning to Step 422;
Step 433, acquiring a Y-coordinate PTAY=PTAGroup{idxCpT}{idxPTAGinCPT}(2,cntPTA) of the current grid row, and updating STYMem=[idxCpT;idxPTAGinCPT;cntPTA];
Step 434, initializing a temporary component type count variable cntCpT1=1;
Step 435, determining whether cntCpT1<numCPT_JL; if so, performing Step 436; otherwise, performing Step 44;
Step 436, determining whether cntCpT1 is not equal to cntCpT; if so, performing Step 437; otherwise, updating cntCpT1=cntCpT1+1, and returning to Step 435;
Step 437, acquiring a temporary component index idxCpT1=CPT_JL(cntCpT1), and acquiring indexes idxSameY=find(abs(PTAGroup{idxCpT1}{cntPTAGinCPT1}(2,:)−PTAY)<boundaryLayer, 1) of grid rows, the distance between Y-coordinates of which and the Y-coordinate of the grid row group corresponding to the main component is less than the boundary layer, in the grid row group corresponding to a temporary component;
Step 438, determining whether numel(idxSameY)>0; if so, performing Step 439; otherwise, updating cntCpT1=cntCpT1+1, and returning to Step 435; and
Step 439, updating cntCpT1=cntCpT1+1, updatingSTYMem=[STYMem [idxCpT1;cntPTAGinCPT1;idxSameY]], and returning to Step 435;
Step 44, looping through existing co-Y-axis grid row combinations, and determining whether assignment has been completed:
Step 441, initializing a co-Y-axis grid row exist flag flagExistY=0, initializing the number numCPTemp=size(STYMem,2) of each type of components in STYMem, and initializing the count variablecntSTM=1 of STYMem;
Step 442, determining whether cntSTM<numSTM; if so, performing Step 443; otherwise, performing Step 446;
Step 443, acquiring the number numCPTinSYM=size(STMatchInfo{cntSTM,1},2) of types of components assigned to the co-Y-axis grid row combinations;
Step 444, determining whether numCPTinSYM is equal to numCPTemp; if so, performing Step 445; otherwise, updating cntSTM=cntSTM+1, and returning to Step 442;
Step 445, determining whether STMatchInfo{cntSTM,1}(1:2,:) is equal to STYMem(1:2,:); if so, updating flagExistY=1, and performing Step 446; otherwise, updating cntSTM=cntSTM+1, and returning to Step 442;
Step 446, determining whether flagExistY is not 0; if so, performing Step 447; otherwise, performing Step 448;
Step 447, updatinggrid row numbers STMatchInfo{cntSTM,3}=[STMatchInfo{cntSTM,3};STYMem(3,:)] correspondingly recorded in STMatchInfo; updating cntPTA=cntPTA+1, and returning to Step 431;
Step 448, updating numSTM=numSTM+1; updatingSTMatchInfo{numSTM,1}=STYMem(1:2,:); updating STMatchInfo{numSTM,3}=STYMem(3,:), and performing Step 45;
Step 45, performing point pair information matching in the X-direction:
Step 451, initializing parameters, wherein the parameters include: an X-direction point pair information storage array STXMem=cell(1,2), the number numSTXM of STXMem, component indexesidxCpT2=STYMem(1,1) of main components in STYMem, grid row groups cntPTAGinCPT2=STYMem(2,1) used by a co-Y-axis grid row group formed by the main components, grid rows cntPTA2=STYMem(3,1) used by the grid row group, grid row indexes idxPtArray2=PTAGroup{idxCpT2}{cntPTAGinCPT2}(1,cntPTA2) used by the main components a grid idxCpT2, row length numPTinPTA2=LengthPTAG{idxCpT2,1}(cntPTAGinCPT2) used by the main components idxCpT2, all head indexes idxHDs2=Head2CPT{idxCpT2,1} corresponding to the main components idxCpT2, the number numHD2=numHd2CpTs(idxCpT2) of heads corresponding to the main components idxCpT2, and a count variable cntHD2=1 of the heads corresponding to the main components;
Step 452, determining whether cntHD2<numHD2; if so, performing Step 453; otherwise, performing Step 48;
Step 453, updating a current head index idxHd2=idxHDs2(cntHD2), and initializing a placement point count variablecntPT2=1 of the current grid row;
Step 454, determining whether cntPT2<numPTinPTA2; if so, performing Step 455; otherwise, updating cntHD2=cntHD2+1, and returning to Step 452; and
Step 455, acquiring a current X-coordinate X2=PtArrayX{idxCpT2, idxPtArray2}(cntPT2), and performing Step 46;
Step 46, at current head positions, checking whether heads where the other components are located correspond to simultaneous placement points:
Step 461, defining the other components other than the main component as secondary components, and initializing a secondary component count variable cntCpT3=1;
Step 462, determining whether cntCpT3<numCPTemp; if so, performing Step 463; otherwise, performing Step 47;
Step 463, acquiring component indexes idxCpT3=STYMem(1,cntCpT3) of secondary components in STYMem, the grid row group cntPTAGinCPT3=STYMem(2,cntCpT3) used as co-Y-axis grid row groups formed by the secondary components, the grid rows cntPTA3=STYMem(3,cntCpT3) used in the grid row groups, grid row indexes idxPtArray3=PTAGroup{idxCpT3}{cntPTAGinCPT3}(1,cntPTA3) used by the secondary components, all head indexes idxHDs3=Head2CPT{idxCpT3,1} corresponding to the secondary components idxCpT3, the number of the heads numHD3=numHd2CpTs(idxCpT3) corresponding to the secondary components idxCpT3, and a temporary variable tmpSTXMem=[idxHd2;cntPT2;cntPTAGinCPT2;idxCpT2] of STXMem;
Step 464, initializing a count variable cntHD3=1 of the heads corresponding to the secondary components;
Step 465, determining whether cntHD3<numHD3; if so, performing Step 466; otherwise, updating cntCpT3=cntCpT3+1, and returning to Step 462;
Step 466, acquiring the indexesidxHd3=idxHDs3(cntHD3) of the heads corresponding to the secondary components; determining whether idxHd3<=idxHd2; if so, updating cntHD3=cntHD3+1, and returning to Step 465; otherwise, performing Step 467;
Step 467, acquiring all X-coordinates Xs3=PtArrayX{idxCpT3, idxPtArray3} of grid rows corresponding to the secondary components; converting coordinates X2 into X-coordinates X2_3=X2+(idxHd3-idxHd2)*HDI of the heads corresponding to the secondary components; acquiring indexes idxSame=find(abs(Xs3−X2_3)<boundaryLayer,1) of placement points corresponding to the coordinates Xs3 having a distance to the coordinates X2_3 less than boundaryLayer; and
Step 468, determining whether numel(idxSame) is not 0; if so, updating tmpSTXMem=[tmpSTXMem[idxHd3;idxSame;cntPTAGinCPT3;idxCpT3]]; otherwise, updating cntHD3=cntHD3+1, and returning to Step 465;
Step 47, looping through all simultaneous placement point combinations, and determining whether assignment of the simultaneous placement point combinations has been completed:
Step 471, sorting tmpSTXMem according to the heads [˜,idxsort]=sort(tmpSTXMem(1,:),‘descend’), tmpSTXMem=tmpSTXMem(:,idxsort), initializing an assigned simultaneous placement point flags flagExistX=0, and acquiring the number numPTemp=size(tmpSTXMem,2) of head indexes stored in tmpSTXMem;
Step 472, determining whether numPTemp>1; if so, acquiring a leftmost head index LeftHd=min(tmpSTXMem(1,:)) in tmpSTXMem, aligning all head indexes in tmpSTXMem with LeftHd as a reference tmpSTXMem(1,:)=tmpSTXMem(1,:)−LeftHd+1, initializing a STXMem count variable cntSTXMem=1, and performing Step 473; otherwise, updating cntPT2=cntPT2+1, and returning to Step 454;
Step 473, determining whether cntSTXMem<numSTXM; if so, performing Step 474; otherwise, performing Step 475;
Step 474, acquiring information numPTinSTXM=size(STXMem{cntSTXMem,1},2) of the number of (cntSTXMem)^{th} assigned placement points; determining whether numPTinSTXM is equal tonumPTemp and STXMem{cntSTXMem,1} is equal to tmpSTXMem; if so, updatingflagExistX=1, and performing Step 475; otherwise, updating cntSTXMem=cntSTXMem+1, and returning to Step 473;
Step 475, determining whether flagExistX is not 0; if so, performing Step 476; otherwise, performing Step 477;
Step 476, searching STXMem{cntSTXMem,2} for indexes the same as LeftHd:idxSame1=find(STXMem{cntSTXMem,2}==LeftHd); if idxSame1 is empty, updating STXMem{cntSTXMem,2}=[STXMem{cntSTXMem,2};LeftHd]; updatingcntPT2=cntPT2+1, and returning to Step 454;
Step 477, updating numSTXM=numSTXM+1, updatingSTXMem{numSTXM,1}=tmpSTXMem, updatingSTXMem{numSTXM,2}=LeftHd, and initializing the placement point count variable cntPTemp=1;
Step 478, determining whether cntPTemp<numPTemp; if so, performing Step 479; otherwise, updatingcntPT2=cntPT2+1, and returning to Step 454;
Step 479, acquiring a temporary component type index a temporary placement point index idxCpt0=tmpSTXMem(4,cntPTemp) and idxPTinPTA0=tmpSTXMem(2,cntPTemp); updating STcounter{idxCpt0,1}{1,1}(idxPTinPTA0)=STcounter{idxCpt0,1}{1,1}(idxPTinPTA0)+1; updatingSTcounter{idxCpt0,1}{1,2}{idxPTinPTA0}=[STcounter{idxCpt0,1}{1,2}{idxP TinPTA0}; [numSTM numSTXMnumPTemp]]; updating cntPTemp=cntPTemp+1, and returning to Step 478;

Step 48, storing STXMem in STMatchInfo: STMatchInfo{numSTM,2}=STXMem; updating cntPTA=cntPTA+1, and returning to Step 432;
Step 49, sorting the numbers of placement points participating in simultaneous placement:
Step 491, acquiring the number numSTcounter=size(STcounter,1) of STcounter, and initializing a count variablecntSTC=1 of STcounter;
Step 492, determining whether cntSTC<numSTcounter; if so, performing Step 493; otherwise, performing Step 497;
Step 493, determining whether STcounter{cntSTC,1} is empty; if so, performing Step 494; otherwise, updating cntSTC=cntSTC+1, and returning to Step 492;
Step 494, acquiring a simultaneous placement length lengthCounter=numel(STcounter{cntSTC,1}{1,1}), and initializing a simultaneous placement length count variable cntLC=1;
Step 495, determining whether cntLC<lengthCounter; if so, performing Step 496; otherwise, updating cntSTC=cntSTC+1, and returning to Step 492;
Step 496, determining whether STcounter{cntSTC,1}{1,2}{cntLC} is not empty; if so, sorting according to the number of simultaneous placements [˜,idxsort]=sort(STcounter{cntSTC,1}{1,2}{cntLC}(:,3),‘descend’), updating STcounter{cntSTC,1}{1,2}{cntLC}=STcounter{cntSTC,1}{1,2}{cntLC}(idxsort,:) according to a sorting result, updating cntLC=cntLC+1, and returning to step 495; otherwise, updating cntLC=cntLC+1, and returning to Step 495;
Step 497, returning STMatchInfo and STcounter, and returning to Step 25.

In this embodiment, the placement point assignment algorithm based on the progressive search rule comprises:
Step 51, performing parameter initialization and head preprocessing:
Step 511, initializing parameters, wherein the parameters include: indexes ST_UHD=[ ] of heads capable of realizing “simultaneous placement” in usedHDs, the number numHD of heads in usedHDs, heads flagSTC1=zeros(numHDs,1) capable of realizing simultaneous placement, heads flagSC=ones(numHDs,1) that have not completed assignment, heads flagSC0=ones(numHDs,1) that have not been subjected to simultaneous placement, a path recording array WaypointX=zeros(1,numHDs1), a placement point-head pair information storage array SeqPTAX, an information storage array RecordX=zeros(1,numHDs) of X-coordinates of placement points corresponding to the heads, and simultaneous heads ST_UHD0 that have been assigned; and
Step 512, head preprocessing: setting a temporary variable usedHDs1=usedHDs of usedHDs, a temporary variable numHDs1=numel(usedHDs1) of numHDs, removing assigned heads usedHDs(ST_UHD0)=[ ] from usedHDs, and updating numHDs=numel(usedHDs);
Step 52 comprising:
Step 521, determining whether sum(flagSC) is not zero; if so, acquiring non-zero coordinate indexesidxnon0=find(WaypointX˜=0) in WaypointX; determining whether flag1stPT is not zero; if so, flagEmpty=idxnon0; otherwise, flagEmpty=[ ]; otherwise, performing Step 58;
Step 522, determining whether flagEmpty is empty; if so, performing Step 522; otherwise, performing Step 524;
Step 523, acquiring idxHD=usedHDs(1), acquiringcntCPt=tmpCPg(idxHD), acquiringidxCpT=usedPTAGinfo{1,1}(1,cntCPt), acquiringidxPTAG=usedPTAGinfo{1,1}(2,cntCPt), acquiringidxPtArray=PTAGroup{idxCpT}{idxPTAG}(1,1), acquiringidxPTinArray=usedPTAGinfo{2,1}{cntCPt}(1), recoding “placement point-head pair” information SeqPTA{cntmc,idxHD}=[idxCpT; idxPTAG;idxPTinArray], removing assigned placement points 0 prevent secondary assignment usedPTAGinfo{2, 1}{cntCPt}(1)=[ ], acquiring the X-coordinate CurrentX=PtArrayX{idxCpT, idxPtArray}(idxPTinArray) of the current assigned point, updating RecordX(1)=CurrentX, updatingflagSC(1)=0, and performing Step 54; and
Step 524, performing assignment under the precondition where assignment of existing heads has been completed, acquiring a non-zero maximum value max WPX=max (WaypointX(idxnon0)) in WaypointX, updating idxHDs=find(WaypointX==maxWPX), updating idxHD=idxHDs(end), updating idxCpT=SeqPTA{cntmc,idxHD}(1), updating idxPTAG=SeqPTA{cntmc,idxHD}(2); updatingidxPtArray=PTAGroup{idxCpT}{idxPTAG}(1,1), updatingidxPTinArray=SeqPTA{cntmc,idxHD}(3), acquiringCurrentX=PtArrayX{idxCpT, idxPtArray}(idxPTinArray); updating flagSC(1)=0, and performing Step 53;
Step 53, determining groups of remaining points in the grid rows according to the progressive search rule:
Step 531, acquiring a head index idxHD0=HD2CPT(cntHDs); acquiring an ideal placement position nextHdX=CurrentX−(idxHD−idxHD0)*HDI of idxHD0 with respect to the previous assigned head, wherein idxHD is the index of the previous assigned head; acquiring cntCPt=tmpCPg(idxHD0); acquiring idxCpT=usedPTAGinfo{1,1}(1,cntCPt); acquiring idxPTAG=usedPTAGinfo{1,1}(2,cntCPt); acquiring idxPtArray=PTAGroup{idxCpT}{idxPTAG}(1,1); indexes acquiring the traversePTAG=usedPTAGinfo{2,1}{cntCPt} of placement points in the grid row corresponding to an component; acquiring X-coordinates traversePTX=PtArrayX{idxCpT, idxPtArray}(traversePTAG) of placement points in the corresponding grid row;
Step 532, acquiring, in traversePTX, the index [˜,idxNextPt]=min(abs(traversePTX−nextHdX)) of a placement point nearest to nextHdX in the grid row;
Step 533, determining whether cntHDs is greater than 1; if so, acquiring indexesidxLastPt=find(traversePTX<RecordX(idxlastX),1), less than RecordX(idxlastX), in traversePTX, and performing Step 543; otherwise, acquiring idxLastPt=find(traversePTX<CurrentX,1), and performing Step 534;
Step 534, determining whether idxLastPt is empty; if so, updating idxLastPt=numel(traversePTAG), and performing Step 535; otherwise, performing Step 535;
Step 535, acquiring a maximum selection range LimNextPt=min([idxLastPt+(idxHD−idxHD0)*mincyc, numel(traversePTAG)]) of the next placement point;
Step 536, determining whether idxNextPt>LimNextPt; if so, performing Step 537; otherwise, performing Step 538;
Step 537, determining whether LimNextPt<=0; if so, updating idxNextPt=1, and performing Step 538; otherwise, idxNextPt=LimNextPt, and performing Step 538;
Step 538, updating idxHD=idxHD0; updating CurrentX0=PtArrayX{idxCpT, idxPtArray}(traversePTAG(idxNextPt)); determining whether CurrentX0 is not empty; if so, performing Step 539; otherwise, performing Step 54; and
Step 539, updating CurrentX=CurrentX0, updatingSeqPTA{cntmc,idxHD0}=[idxCpT;idxPTAG;traversePTAG(idxNextPt)], and updating RecordX(cntHDs)=CurrentX;
removing assigned points usedPTAGinfo{2,1}{cntCPt}(idxNextPt)=[ ];
Step 54 comprising:
Step 541, determining whether sum(flagSC) is not 0; if so, updating the flag flagSC1=flagSC+flagSC0, wherein if flagSC1 is 1, it indicates that assignment of the current head has been completed, but assignment of “simultaneous placement” points has not been performed on the placement point; updating indexes with the flag flagSC1 of 1: idxHD_SC1=find(flagSC1==1); acquiring the number numHD_SC=numel(idxHD_SC1) of the indexes idxHD_SC1; initializing a head assignment count variablecntHD_SC=1; otherwise, performing Step 57;
Step 542, determining whether cntHD_SC<numHD_SC; if so, updating cntHDs=idxHD_SC1(cntHD_SC), updating flagSC0(cntHDs)=0, acquiringidxHD1=usedHDs(cntHDs), and performing Step 543; otherwise, performing Step 56;
Step 543, determining whether is empty(SeqPTA{cntmc,idxHD1}) is true; if so, updating cntHD_SC=cntHD_SC+1, and returning to Step 542; otherwise, acquiring cntCPt=tmpCPg(idxHD1); acquiring the component type index idxCpT=usedPTAGinfo{1,1}(1,cntCPt); acquiring idxPTinArray=SeqPTA{cntmc,idxHD1}(3); updating flagHD1st=0, and performing Step 544;
Step 544, determining whether STcounter{idxCpT,1}{1,1}(idxPTinArray) is not 0; if so, determining that simultaneous placement is available, and performing Step 545; otherwise, performing Step 55;
Step 545, acquiring co-Y-axis indexes idxSYMem=STcounter{idxCpT,1}{1,2}{idxPTinArray}(1,1), acquiring co-X-axis coordinate indexes idxSTXMem=STcounter{idxCpT,1}{1,2}{idxPTinArray}(1,2), acquiring indexes HD2PT=STMatchInfo{idxSYMem, 2}{idxSTXMem,1} of relative heads, acquiring the index Hds1st=STMatchInfo{idxSYMem, 2}{idxSTXMem,2} of a main head, initializing a main head count variable cntHds1st=1, and initializing a relative head count variable cntHds=1;
Step 546, determining whether cntHds1st<numHds1st; if so, performing Step 547; otherwise, performing Step 55;
Step 547, determining whether cntHds<numHdinMem; if so, performing Step 548; otherwise, performing Step 549;
Step 548, determining whether Hds1st(cntHds1st)+HD2PT(1,cntHds)−1 is equal to idxHD1 and HD2PT(2,cntHds) is equal toidxPTinArray; if so, updating HD1st=Hds1st(cntHds1st), updating flagHD1st=1, updatingcntHds1st=cntHds1st+1, and returning to Step 546; otherwise, updating cntHds=cntHds+1, and returning to Step 547;
Step 549, determining whether flagHD1st is not 0; if so, performing Step 55; otherwise, updating cntHds1st=cntHds1st+1, and returning to Step 546; Step 55 comprising:
Step 551, determining whether flagHD1st is not 0; if so, initializing a “simultaneous placement” success flag STsuccess=0, initializing a temporary variable flagSTC1tmp=flagSTC1 of flagSTC1, initializing a temporary variable flagSCtmp=flagSC of flagSC, initializing a temporary variable ST_UHDtmp=ST_UHD of ST_UHD, and initializing the head count variable cntHds=1; otherwise, updating ST_UHD=cntHDs, updating cntHD_SC=cntHD_SC+1, and returning to Step 542;
Step 552, determining whether cntHds<numHdinMem; if so, updating idxHD0=HD1st+HD2PT(1,cntHds)−1, and performing Step 553; otherwise, performing Step 557;
Step 553, determining whether SeqPTA{cntmc,idxHD0} is empty; if so, updating idxCpT=HD2PT(4,cntHds), updatingidxPTAG=HD2PT(3,cntHds), updating idxPTinArray=HD2PT(2,cntHds), updatingcntCPt1=tmpCPg(idxHD0), acquiring, from usedPTAGinfo{2,1}{cntCPt1}, point indexes satisfying the conditionidxPTleft=find(usedPTAGinfo{2,1}{cntCPt1}==idxPTinArray), and performing Step 554; otherwise, performing Step 555;
Step 554, determining whether idxPTleft is not empty; if so, updating SeqPTA{cntmc, idxHD0}=[idxCpT;idxPTAG;idxPTinArray], eliminating assigned placement point information usedPTAGinfo{2,1}{cntCPt1}(idxPTleft)=[ ], updating STsuccess=1, acquiring the position cntUHDs=find(usedHDs==idxHD0) of idxHD0 in a used head group, updating flagSC0(cntUHDs)=0, and performing Step 555;
Step 555, acquiring the position cntUHDs=ind(usedHDs==idxHD0) of idxHD0 in the used head group; determining whether cntUHDs is not 1; if so, updating flagSTC1tmp(cntUHDs)=1, and performing Step 556; otherwise, directly performing Step 556;
Step 556, updating ST_UHDtmp=[ST_UHDtmpontUHDs]; updating flagSCtmp(cntUHDs)=0, updating cntHds=cntHds+1, and returning to Step 552;
Step 557, determining whether STsuccess is not 0; if so, updating flagSTC1=flagSTC1tmp, updating flagSC=flagSCtmp, updatingST_UHD=ST_UHDtmp, and performing Step 558; otherwise, performing Step 558; and
Step 558, updating cntHds1st=cntHds1st+1, and returning to Step 546;
Step 56, determining subsequent points based on the progressive search rule:
Step 561, initializing the head count variable cntHDs=1;
Step 562, determining whether cntHDs<numHDs; if so, performing Step 563; otherwise, returning to Step 54;
Step 563, determining whether flagSC(cntHDs) is not 0; if so, performing Step 564; otherwise, updating cntHDs=cntHDs+1, and returning to Step 562;
Step 564, determining whether cntHDs>1 and flagSTC1(cntHDs−1) is not 0; if so, updating idxlastX=find(flagSTC1(1:(cntHDs−2))==0,1), and performing Step 565; otherwise, updating idxlastX=cntHDs−1, and performing Step 565; and
Step 565, performing Step 53 to determining groups of remaining points in the grid rows according to the progressive search rule, updatingflagSC(cntHDs)=0, and returning to Step 54;
Step 57 comprising:
Step 571, acquiring heads that fail to realize simultaneous placement idxNotSTC=find(flagSTC1==0); acquiring components that fail to realize simultaneous placementtmpCPg1=tmpCPg(usedHDs(idxNotSTC)); acquiring SeqPTAtmp=SeqPTA(cntmc,:); determining whether tmpCPg1 is not empty; if so, performing Step 572; otherwise, performing Step 58;
Step 572, acquiring identical component indexes idxsame=find(tmpCPg1==tmpCPg1(1)); determining whether numel(idxsame)>1; if so, performing Step 573; otherwise, performing Step 576;
Step 573, acquiring heads corresponding to the same type of components that fail to realize simultaneous placementidxNSTC1=idxNotSTC(idxsame), sorting storage sites in RecordX [˜,idxsortRX]=sort(RecordX(idxNSTC1),‘descend’), acquiring corresponding head indexesidxUhd=usedHDs(idxNSTC1), and initializing a non-simultaneous placement count variable cntNSTC=1;
Step 574, determining whether cntNSTC<numel(idxsortRX); if so, performing Step 575; otherwise, performing Step 576;
Step 575, updating SeqPTA{cntmc,idxUhd(cntNSTC)}=SeqPTAtmp{1,idxUhd(idxsortRX(cntNSTC))}, updatingcntNSTC=cntNSTC+1, and returning to Step 574; and
Step 576, eliminating assigned placement point information tmpCPg1(idxsame)=[ ], idxNotSTC(idxsame)=[ ], and returning to Step 571; and
Step 58, evaluating the movement time in the current cycle:
Step 581, initializing the indexes of heads that fail to realize simultaneous placementNoSTHDs=1:numHDs, NoSTHDs(ST_UHD)=[ ], and initializing the movement time TinCYC=0;
Step 582, initializing the head count variablecntHDs=1;
Step 583, determining whether cntHDs<numHDs1; if so, acquiring the head index idxHD=usedHDs1(cntHDs), and performing Step 584; otherwise, performing Step 585;
Step 584, determining whether SeqPTA{cntmc,idxHD} is not empty; if so, acquiringidxCpT=SeqPTA{cntmc,idxHD}(1), acquiringidxPTAG=SeqPTA{cntmc,idxHD}(2), acquiring idxPtArray=PTAGroup{idxCpT}{idxPTAG}(1,1), acquiring idxPTinArray=SeqPTA{cntmc,idxHD}(3), waypoints storing WaypointX(cntHDs)=PtArrayX{idxCpT, idxPtArray}(idxPTinArray)−(idxHD−1)*HDI corresponding to the heads, updating cntHDs=cntHDs+1, and returning to Step 583; otherwise, updating cntHDs=cntHDs+1, and returning to Step 583;
Step 585, sorting WaypointX:WaypointX=sort(WaypointX); acquiring the X-coordinate currentX=WaypointX(1) of the first placement point; initializingcntHDs=2;
Step 586, determining whether cntHDs<numHDs1; if so, performing Step 587; otherwise, performing Step 588;
Step 587, acquiring the X-coordinate nextX=WaypointX(cntHDs) of the next placement point; updating TinCYC=TinCYC+abs(currentX−nextX)/VX; updating currentX=nextX, and updating cntHDs=cntHDs+1; and
Step 588, returning usedPTAGinfo, SeqPTA, TinCYC, NoSTHD and ST_UHD.

Remark: Step 352 and Step 255 of Step 5 are invoked.

In this embodiment, the placement point assignment algorithm based on the simultaneous placement-maximized assignment rule comprises:
Step 61, initializing parameters, wherein the parameters include: grid row group usage informationusedPTAGinfo, a correspondingtemporary variable usedPTAGinfo1, finally processed grid row group information usedPTAGinfoB, the number of used heads numHDs=numel(usedHDs), headscapable of realize “simultaneous placement” ST_UHD=[ ] in usedHDs, a corresponding final result variable ST_UHDB, a final result variable SeqPTAB of SeqPTA, the number numPTinCpT=zeros(1,numCPTinCPg) of placement points corresponding to each component, and a flag flagFree=cell(1,numCPTinCPg) indicting whether each point is vacant;
Step 62, acquiring update parameter information:
Step 621, initializing a component count variable cntCPTinCPg=1;
Step 622, determining whether cntCPTinCPg<numCPTinCPg; if so, performing Step 623; otherwise, performing Step 624;
Step 623, updating numPTinCpT(cntCPTinCPg)=numel(usedPTAGinfo1{2,1}{cntCPTinCPg}); updating flagFree{cntCPTinCPg}=ones(1,numPTinCpT(cntCPTinCPg)); updating cntCPTinCPg=cntCPTinCPg+1, and returning to Step 622;
Step 624, updating a maximum number of simultaneous placements numSTBest=0, updating the optimal movement time TinCycBest=inf, and updating flagPTinCpT=ones(1,numCPTinCPg), flagPTinCpT=ones(1,numCPTinCPg);
Step 63 comprising:
Step 631, determining whether flagPTinCpT(numCPTinCPg)<numPTinCpT(numCPTinCPg); if so, overloading a variable flagFree1=flagFree; usedPTAGinfo1=usedPTAGinfo; SeqPTA1=SeqPTA; ST_UHD1=ST_UHD; flagSC=ones(numHD,1); flagSC(usedHDs)=flagSC(usedHDs)*0; flagPTinCpT1=flagPTinCpT; initializing WaypointX=zeros(1,numHDs); initializingTinCyc=0; initializing the head count variable cntHDs=1, and performing Step 632; otherwise, performing Step 69;
Step 632, determining whether cntHDs<=numHDs; if so, acquiring the head index idxHD1=usedHDs(cntHDs), and performing Step 633; otherwise, performing Step 68;
Step 633, determining whether flagSC(idxHD1) is 0; if so, performing Step 634; otherwise, updating cntHDs=cntHDs+1, and returning to Step 632;
Step 634, acquiring the component count variable cntCPt=tmpCPg(idxHD1), acquiring the component type index idxCpT=usedPTAGinfo1{1,1}(1,cntCPt), and acquiring the number numPTmp=numel(usedPTAGinfo1{2,1}{cntCPt}) of remaining points in grid rows corresponding to the current type of components;
Step 635, determining whether numPTmp is 0; if so, updating cntHDs=cntHDs+1, and returning to Step 632; otherwise, performing Step 636; and
Step 636, acquiring a rightmost placement point MostRightPT=min([flagPTinCpT1(cntCPt) numPTmp]) corresponding to the current component, acquiring indexes idxnon0=find(WaypointX>0) of non-zero points in WaypointX, acquiring the number numnon0=numel(idxnon0) of elements in idxnon0, initializing a time storage array WPXTime=zeros(1,numnon0), acquiring coordinates WPX1=WaypointX(idxnon0) of the non-zero points, initializing a simultaneous point exist flag flagHD1st=0, initializing the optimal movement time minWPXTBest=100, and initializing the optimal first head HD1stBest=0;
Step 64, determining whether flagHD1st is 0; if so, performing Step 641; otherwise, performing Step 66;
Step 641, determining whether flagFree1{cntCPt}(MostRightPT) is 1; if so, performing Step 642; otherwise, performing Step 659;
Step 642, acquiring a point index idxPTinArray1=usedPTAGinfo1{2,1}{cntCPt}(MostRightPT) of the point MostRightPT in the grid row;
Step 643, determining whether there is ideal simultaneous placement isempty(STcounter{idxCpT,1}{1,2}{idxPTinArray1}) for the point; if so, performing
Step 644; otherwise, performing Step 66;
Step 644, acquiring a Y-direction simultaneous placement index idxSYMem=STcounter{idxCpT,1}{1,2}{idxPTinArray1}(1,1), acquiring an X-direction simultaneous placement index idxSTXMem-STcounter{idxCpT,1}{1,2}{idxPTinArray1}(1,2), acquiring indexes HD2PT=STMatchInfo{idxSYMem,2}{idxSTXMem,1} of heads corresponding to simultaneous placement points, acquiring the number numHds1st=numel(Hds1st) of main heads, and acquiring the number numHdinMem=size(HD2PT,2) of HD2PT;
Step 645, initializing a main head count variable cntHds1st=1;
Step 646, determining whether cntHds1st<numHds1st; if so, performing Step 647; otherwise, performing Step 658;
Step 647, acquiring head indexes idxHds=Hds1st(cntHds1st)+HD2PT(1,:)−1 of simultaneous placement groups corresponding to the main heads; and
Step 648, determining whether all heads in idxHds have been assigned; if so, updating cntHds1st=cntHds1st+1, and returning to Step 646; otherwise, performing Step 65;
Step 65 comprising:
Step 651, initializing the head count variable cntHds=1; determining whether cntHds<numHdinMem; if so, performing Step 652; otherwise, performing Step 657;
Step 652, determining whether Hds1st(cntHds1st)+HD2PT(1,cntHds)−1 is equal to idxHD1 and HD2PT(2,cntHds)==idxPTinArray1; if so, performing Step 653; otherwise, updating cntHds=cntHds+1, and returning to Step 651;
Step 653, acquiring indexes HD1st0=Hds1st(cntHds1st) of the main heads; determining whether idxnon0 is empty; if so, updating HD1stBest=HD1st0, updating flagHD1st=1, updating idxSYMemBest=idxSYMem, updating idxSTXMemBest=idxSTXMem, and performing Step 657; otherwise, performing Step 654;
Step 654, acquiringidxCpT=HD2PT(4,cntHds), acquiring idxPTAG=HD2PT(3,cntHds), acquiring idxPtArray=PTAGroup{idxCpT}{idxPTAG}(1,1), acquiringidxPTinArray2=HD2PT(2,cntHds), acquiringidxHD0=HD1st0+HD2PT(1,cntHds)−1, transforming placement point coordinates to corresponding placement points WPXtmp=PtArrayX{idxCpT, idxPtArray}(idxPTinArray2)−(idxHD0-1)*HDI, and initializing a non-zero placement point count variable cntnon0=1;
Step 655, determining whether cntnon0<numnon0; if so, updating WPXTime(cntnon0)=abs(WPXtmp−WPX1(cntnon0))/VX, updatingcntnon0=cntnon0+1, and returning to Step 655; otherwise, performing Step 656;
Step 656, acquiring a minimum time minWPXTime=min(WPXTime); determining whether minWPXTBest>minWPXTime; if so, updating minWPXTBest=minWPXTime, updatingHD1stBest=HD1st0, updating idxSYMemBest=idxSYMem, updating idxSTXMemBest=idxSTXMem, and performing Step 657; otherwise, performing Step 657;
Step 657, determining whether flagHD1st is not 0; if so, performing Step 658; otherwise, cntHds1st=cntHds1st+1, and returning to Step 646;
Step 658, determining whether flagHD1st is not 0; if so, performing Step 66; otherwise, performing Step 659; and
Step 659, updating MostRightPT=MostRightPT+1; determining whether MostRightPT>numPTmp; if so, determining that all points fail to realize simultaneous placement, and performing Step 66; otherwise, returning to Step 64;
Step 66 comprising:
Step 661, determining whether flagHD1st is not 0; if so, updating HD2PT=STMatchInfo{idxSYMemBest, 2}{idxSTXMemBest,1}; initializing the “simultaneous placement” success flag STsuccess=0, initializing the temporary variable ST_UHDtmp=ST_UHD1 of heads capable of realizing simultaneous placement, initializing the temporary variable WaypointX1=WaypointX of WaypointX, initializing a head assignment flag flagSC1=flagSC, initializingSeqPTA2=SeqPTA1, initializingusedPTAGinfo2=usedPTAGinfo1, initializingflagFree2=flagFree1, initializingcntST=0, acquiring the number numHdinMem=size(HD2PT,2) of elements in HD2PT,initializing the head count variable cntHds=1, and performing Step 662; otherwise, updating cntHDs=cntHDs+1, and returning to Step 632;
Step 662, determining whether cntHds<numHdinMem; if so, performing Step 663; otherwise, performing Step 668;
Step 663, acquiring the head index idxHD0=HD1stBest+HD2PT(1,cntHds)−1; determining whether SeqPTA2{cntmc,idxHD0} is empty; if so, acquiringidxCpT=HD2PT(4,cntHds), acquiringidxPTAG=HD2PT(3,cntHds), acquiringidxPtArray=PTAGroup{idxCpT}{idxPTAG}(1,1), acquiringidxPTinArray2=HD2PT(2,cntHds), acquiringcntCPt1=tmpCPg(idxHD0), acquiring the position idxPTleft=find(usedPTAGinfo2{2,1}{cntCPt1}==idxPTinArray2) of idxPTinArray2 in remaining grid rows, and performing Step 664; otherwise, updating cntHds=cntHds+1, and returning to Step 662;
Step 664, determining whether the current placement point has been assigned, that is, whether flagFree2{cntCPt1}(idxPTleft) is empty; if so, updating cntHds=cntHds+1, and returning to Step 662; otherwise, performing Step 665;
Step 665, determining whether idxPTleft is empty; if so, updating cntST=cntST+1, and performing Step 666; otherwise, updating cntHds=cntHds+1, and returning to Step 662;
Step 666, determining whether cntST>1; if so, updating STsuccess=1; otherwise, performing Step 667;
Step 667, updating SeqPTA2{cntmc,idxHD0}=[idxCpT;idxPTAG;idxPTinArray2]; eliminating assigned placement points usedPTAGinfo2{2,1}{cntCPt1}(idxPTleft)=[ ]; updating flagFree2{cntCPt1}(idxPTinArray2)=0; acquiring the position cntUHDs=find(usedHDs==idxHD0) of idxHD0 in the used head group; updating ST_UHDtmp=[ST_UHDtmpcntUHDs]; updating flagSC1(idxHD0)=1; updating WaypointX1(idxHD0)=PtArrayX{idxCpT, idxPtArray}(idxPTinArray2)−(idxHD0-1)*HDI; updating cntHds=cntHds+1, and returning to Step 662;
Step 668, determining whether STsuccess is not 0; if so, updating cntHDs=cntHDs+1, updating TinCyc=TinCyc+minWPXTBest, updating ST_UHD1=ST_UHDtmp, updatingWaypointX=WaypointX1, updating flagSC=flagSC1, updating SeqPTA1=SeqPTA2, updating usedPTAGinfo1=usedPTAGinfo2, updating flagFree1=flagFree2, and returning to Step 632; otherwise, performing Step 669;
Step 669, updatingflagPTinCpT1(cntCPt)=flagPTinCpT1(cntCPt)+1; determining whether flagPTinCpT1(cntCPt)>numPTinCpT(cntCPt); if so, updatingcntHDs=cntHDs+1, updatingflagPTinCpT1=flagPTinCpT, and returning to Step 632; otherwise, returning to Step 632;
Step 67, updating a current optimal assignment result:
Step 671, acquiring the number numST1=numel(ST_UHD1) of heads capable of realizing simultaneous placement;
Step 672, determining whether numSTBest<numST1, or numSTBest==numST1 and TinCyc<TinCycBest; if so, performing Step 673; otherwise, performing Step 674;
Step 673, updating numSTBest=numST1, updating TinCycBest=TinCyc, updating usedPTAGinfoB=usedPTAGinfo1, updating SeqPTAB=SeqPTA1, and updating ST_UHDB=ST_UHD1;
Step 674, updating flagPTinCpT(1)=flagPTinCpT(1)+1, and initializing the component count variable cntCPTinCPg=2;
Step 675, determining whether cntCPTinCPg<numCPTinCPg; if so, performing Step 676; otherwise, returning to Step 63;
Step 676, determining whether flagPTinCpT(cntCPTinCPg−1)>numPTinCpT(cntCPTinCPg−1); if so, performing Step 677; otherwise, returning to Step 63;
Step 677, updating flagPTinCpT(cntCPTinCPg)=flagPTinCpT(cntCPTinCPg)+1, and updating flagPTinCpT(cntCPTinCPg-1)=1; and
Step 68, updating returned values usedPTAGinfo-usedPTAGinfoB, SeqPTA=SeqPTAB, ST_UHD=ST_UHDB, and returning to Step 255.

In this embodiment, the process of completing placement point assignment of remaining heads by means of the nearest insertion method comprises:
Step 71, initializing parameters, wherein the parameters include: a first assignment cycle cycfirst=CPg1stCyc(cntCPg), a last assignment cycle cyclast=min([cyclast,ceilCycle(cntCPg)]), the number tmpNumPT=numPTinCpT of placement points corresponding to components, corresponding X-coordinates, Y-coordinates and serial numbers of placement pointsCpTX2=CpTX0, CpTY2=CpTY0, CpNo2=CpNo0, and an intermediate variable tmpOCP=OrderCp of the component allocation result;
Step 72, updating a grid row assignment result into tmpOCP, and eliminating information of assigned grid rows:
Step 721, initializing the component type count variable cntCpT=1;
Step 722, determining whether cntCpT<numCPT_JL; if so, performing Step 723; otherwise, performing Step 73;
Step 723, acquiringidxCpT=CPT_JL(cntCpT), acquiring the head index idxHds=Head2CPT0{idxCpT,1}, updating tmpOCP(cycfirst:cyclast,idxHds)=preOCP(cycfirst:cyclast,idxHds), and initializing the cycle count variable cntcyc=cycfirst;
Step 724, determining whether cntcyc<cyclast; if so, initializing the head count variablecnts=1, and performing Step 725; otherwise, updating cntCpT=cntCpT+1, and returning to Step 722;
Step 725, determining whether cnts<numHds; if so, performing Step 726; otherwise, cntcyc=cntcyc+1, returning to Step 724;
Step 726, acquiring the head index idxHd=idxHds (cnts), acquiring indexes idxDeleteCp=find(CpNo2{idxCpT}==preOCP(cntcyc,idxHd),1) of placement points that need to be deleted;
Step 727, determining whether idxDeleteCp is not empty; if so, performing Step 728; otherwise, cnts=cnts+1, returning to Step 725;
Step 728, eliminating assigned placement point information CpTX2{idxCpT}(idxDeleteCp)=[ ], CpTY2{idxCpT}(idxDeleteCp)=[ ], CpNo2{idxCpT}(idxDeleteCp)=[ ]; updating the number tmpNumPT(idxCpT)=tmpNumPT(idxCpT)−1 of components; updating cnts=cnts+1, and returning to Step 725;
Step 73, updating indexes unsureS=find(CPg(cntCPg,:)˜=0) of to-be-assigned heads corresponding to a new component group and the number numUsS=numel(unsureS) of the to-be-assigned heads;
Step 74, initializing the cycle count variable cntcyc=cycfirst;
Step 75, determining whether cntcyc<cyclast; if so, performing Step 67; otherwise, completing matching of remaining non-assigned placement points, and returning to Step 28;
Step 76, initializing a temporary variable unsureS0=unsureS; searching tmpOCP for indexes idxsureS=find(tmpOCP(cntcyc,unsureS0)>0) of assigned heads;
acquiring confirmed heads sureS0-unsureS (idxsureS), and acquiring the number numsS0=numel(sureS0) of the confirmed heads; deleting the confirmed heads unsureS0(idxsureS)=[ ]; acquiring the number numUnS=numel(unsureS0) of non-confirmed heads;
Step 77, determining whether numUnS is 0; if so, updating cntcyc=cntcyc+1, and returning to Step 75; otherwise, performing Step 78; and
Step 78, assigning non-assigned heads by means of the nearest insertion method, updating cntcyc=cntcyc+1, and returning to Step 75.

In this embodiment, the specific process of outputting the placement path optimization result is as follows:
the placement point assignment result PA corresponding to each head in each pick-and-place cycle is obtained in Step 28; based on the shortest path principle, placement points in each pick-and-place cycle are sorted to obtain a placement sequence corresponding to the heads, that is, the placement sorting result PS; and the final placement path optimization results PA and PS are output.

The advantageous effects of the present invention are verified by the following exemplary applications:

Exemplary Application 1: the time-optimal placement path optimization method for surface mounters in this exemplary application is specifically implemented by the following steps:

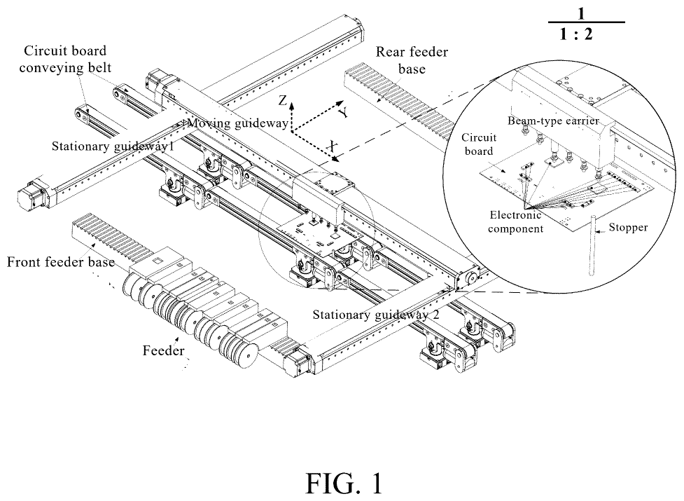

This exemplary application illustrates the placement path optimization process of a surface mounter with a six-head beam-type carrier before assembly of a circuit board adopting an array-type layout, as shown in FIG. 1.

Circuit board production data to be imported are listed in Table 3, including one type of components and 78 placement points.

TABLE 3
Production data of circuit board adopting array-type layout

| Serial number of | X-coordinate | Y-coordinate |
|---|---|---|
| placement points | (mm) | (mm) |
| 1 | −103.4 | 0 |
| 2 | −17.4 | 0 |
| 3 | −77.6 | 0 |
| 4 | −26 | 0 |
| 5 | −86.2 | 0 |
| 6 | −0.2 | 0 |
| 7 | −103.4 | 8.2 |
| 8 | −17.4 | 8.2 |
| 9 | −77.6 | 8.2 |
| 10 | −26 | 8.2 |
| 11 | −86.2 | 8.2 |
| 12 | −0.2 | 8.2 |
| 13 | −103.4 | 16.4 |
| 14 | −17.4 | 16.4 |
| 15 | −77.6 | 16.4 |
| 16 | −26 | 16.4 |
| 17 | −86.2 | 16.4 |
| 18 | −0.2 | 16.4 |
| 19 | −103.4 | 24.6 |
| 20 | −17.4 | 24.6 |
| 21 | −77.6 | 24.6 |
| 22 | −26 | 24.6 |
| 23 | −86.2 | 24.6 |
| 24 | −0.2 | 24.6 |
| 25 | −103.4 | 32.8 |
| 26 | −17.4 | 32.8 |
| 27 | −77.6 | 32.8 |
| 28 | −26 | 32.8 |
| 29 | −86.2 | 32.8 |
| 30 | −0.2 | 32.8 |
| 31 | −103.4 | 41 |
| 32 | −17.4 | 41 |
| 33 | −77.6 | 41 |
| 34 | −26 | 41 |
| 35 | −86.2 | 41 |
| 36 | −0.2 | 41 |
| 37 | −94.8 | 0 |
| 38 | −8.8 | 0 |
| 39 | −69 | 0 |
| 40 | −34.6 | 8.2 |
| 41 | −94.8 | 8.2 |
| 42 | −8.8 | 8.2 |
| 43 | −94.8 | 16.4 |
| 44 | −8.8 | 16.4 |
| 45 | −69 | 16.4 |
| 46 | −34.6 | 24.6 |
| 47 | −94.8 | 24.6 |
| 48 | −8.8 | 24.6 |
| 49 | −94.8 | 32.8 |
| 50 | −8.8 | 32.8 |
| 51 | −69 | 32.8 |
| 52 | −34.6 | 41 |
| 53 | −94.8 | 41 |
| 54 | −8.8 | 41 |
| 55 | −69 | 8.2 |
| 56 | −43.2 | 8.2 |
| 57 | −60.4 | 0 |
| 58 | −34.6 | 0 |
| 59 | −60.4 | 16.4 |
| 60 | −34.6 | 16.4 |
| 61 | −69 | 41 |
| 62 | −43.2 | 41 |
| 63 | −69 | 24.6 |
| 64 | −43.2 | 24.6 |
| 65 | −60.4 | 32.8 |
| 66 | −34.6 | 32.8 |
| 67 | −60.4 | 8.2 |
| 68 | −43.2 | 0 |
| 69 | −43.2 | 16.4 |
| 70 | −43.2 | 32.8 |
| 71 | −51.8 | 8.2 |
| 72 | −51.8 | 0 |
| 73 | −51.8 | 24.6 |
| 74 | −60.4 | 24.6 |
| 75 | −60.4 | 41 |
| 76 | −51.8 | 16.4 |
| 77 | −51.8 | 32.8 |
| 78 | −51.8 | 41 |

In this exemplary application, the placement point assignment result PA and the placement sorting result PS obtained based on the time-optimal placement path optimization method provided by the invention are as follows:

$$PA = [ \begin{matrix}37 & 39 & 5 & 57 & 4 & 6 \\ 1 & 3 & 68 & 2 & 58 & 38 \\ 41 & 55 & 11 & 67 & 10 & 12 \\ 7 & 9 & 56 & 8 & 40 & 42 \\ 43 & 45 & 17 & 59 & 16 & 18 \\ 13 & 15 & 69 & 14 & 60 & 44 \\ 47 & 63 & 23 & 74 & 22 & 24 \\ 19 & 21 & 64 & 20 & 46 & 48 \\ 49 & 51 & 29 & 65 & 28 & 30 \\ 25 & 27 & 70 & 26 & 66 & 50 \\ 53 & 61 & 35 & 75 & 34 & 36 \\ 31 & 33 & 62 & 32 & 52 & 54 \\ 78 & 77 & 73 & 76 & 71 & 72\end{matrix} ] PS = [ \begin{matrix}4 & 6 & 3 & 5 & 2 & 1 \\ 3 & 1 & 4 & 2 & 5 & 6 \\ 4 & 6 & 3 & 5 & 2 & 1 \\ 6 & 5 & 2 & 4 & 1 & 3 \\ 4 & 6 & 3 & 5 & 2 & 1 \\ 3 & 1 & 4 & 2 & 5 & 6 \\ 4 & 6 & 3 & 5 & 2 & 1 \\ 3 & 1 & 4 & 2 & 5 & 6 \\ 4 & 6 & 3 & 5 & 2 & 1 \\ 6 & 5 & 2 & 4 & 1 & 3 \\ 4 & 6 & 3 & 5 & 2 & 1 \\ 3 & 1 & 4 & 2 & 5 & 6 \\ 6 & 5 & 4 & 3 & 2 & 1\end{matrix} ]$$

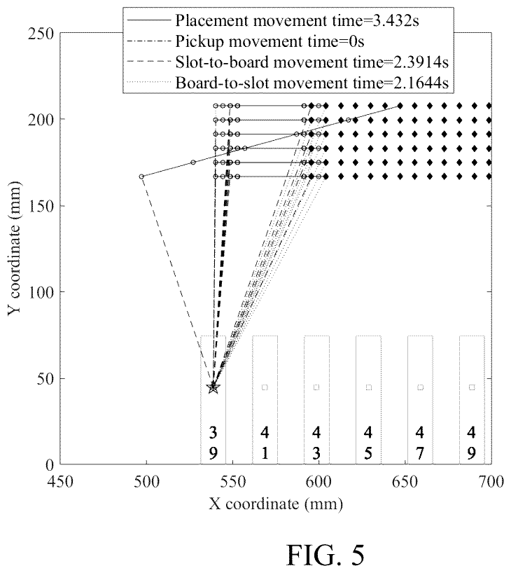

The placement path optimization result is shown in FIG. 5, the movement time of the carrier along a placement path obtained by the invention is TT₁=3.432 s, and 24 approximate simultaneous placements are realized (the approximate simultaneous placements are indicated in bold in PA and PS).

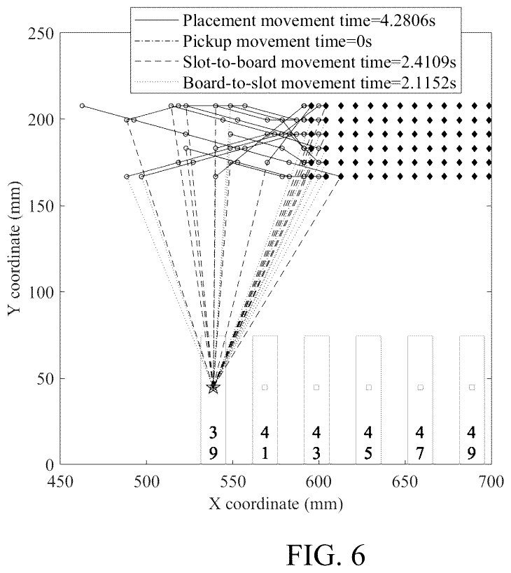

As a contrast, a placement path obtained by commercial software is shown in FIG. 6, the corresponding movement time is TT₀=4.2806 s, and 15 approximate simultaneous placements are realized. In this exemplary application, the invention shorts the SMT movement time by 100%*(TT₀−TT₁)/TT₀=19.82%.

It can be seen, by comparing the placement path optimization results in FIG. 5 and FIG. 6, that in the assembly process of the circuit board adopting an array-type layout, the invention can effectively adapt to the distribution rule of the placement points, implement a placement process step-by-step, balance the placement movement times in different cycles and realize more approximate simultaneous placements by classifying placement points into grid row groups according to their distribution and acquiring approximate simultaneous placement information of the placement points in the grid row groups, thus greatly shortening the SMT movement time and improving the circuit board assembly efficiency of the surface mounter.

Exemplary Application 2: the time-optimal placement path optimization method for surface mounters in this exemplary application is specifically implemented by the following steps:

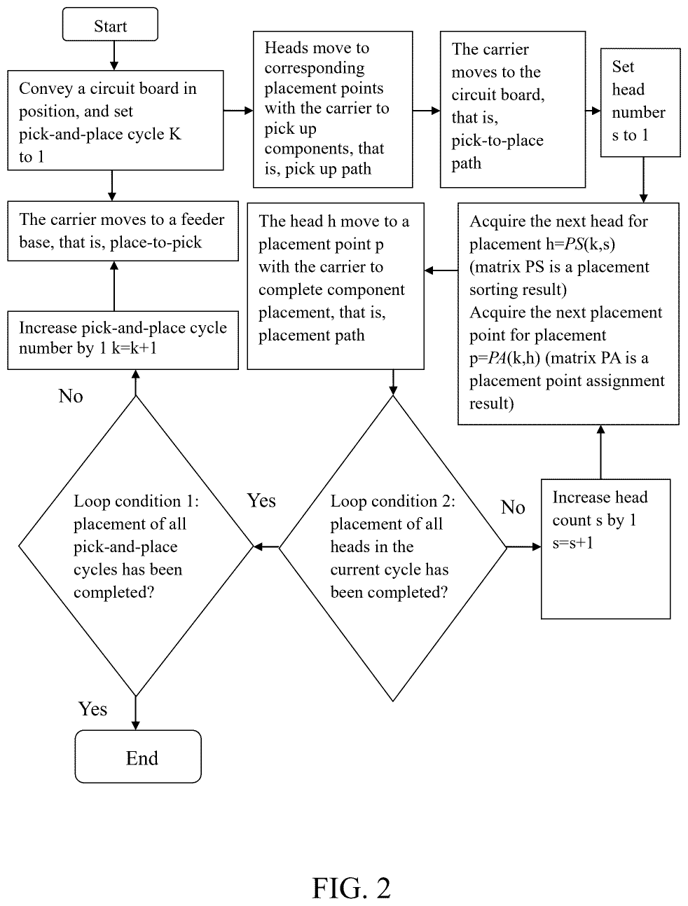

This exemplary application illustrates the placement path optimization process of a surface mounter with a six-head beam-type carrier before the assembly of a circuit board adopting a hybrid layout, as shown in FIG. 2.

Circuit board production data to be imported are listed in Table 4, including ten types of components and 54 placement points.

TABLE 4
Production data of circuit board adopting hybrid layout

| Serial number | Type of | X-coordinate | Y-coordinate |
|---|---|---|---|
| of components | components | (mm) | (mm) |
| 1 | C1 | −192.3 | 18.4 |
| 2 | C2 | −102.8 | −7.6 |
| 3 | C3 | −199.8 | 31.1 |
| 4 | C4 | −199.8 | 66.7 |
| 5 | C5 | −156.2 | 0.3 |
| 6 | C6 | −196.0 | 14.5 |
| 7 | C2 | −83.6 | −7.6 |
| 8 | C3 | −199.8 | 48.7 |
| 9 | C5 | −29.5 | 0.1 |
| 10 | C6 | 4.8 | 80.3 |
| 11 | C1 | 1.1 | 76.4 |
| 12 | C4 | 11.2 | 97.7 |
| 13 | C7 | −125.6 | 0.3 |
| 14 | C8 | −193.6 | 82.8 |
| 15 | C6 | −195.9 | 82.8 |
| 16 | C1 | −192.3 | 86.7 |
| 17 | C4 | −199.7 | 135.0 |
| 18 | C4 | 8.6 | 28.1 |
| 19 | C7 | 0.0 | 0.0 |
| 20 | C8 | 2.4 | 80.3 |
| 21 | C6 | 7.4 | 149.9 |
| 22 | C1 | 3.7 | 146.0 |
| 23 | C9 | −196.6 | 18.4 |
| 24 | C8 | −193.6 | 14.5 |
| 25 | C7 | −39.4 | 0.1 |
| 26 | C3 | 11.2 | 115.7 |
| 27 | C8 | 5.0 | 149.9 |
| 28 | C7 | −146.5 | 0.2 |
| 29 | C9 | −197.6 | 31.0 |
| 30 | C9 | −197.6 | 48.6 |
| 31 | C3 | −199.7 | 99.4 |
| 32 | C3 | −199.7 | 117.0 |
| 33 | C7 | −60.0 | 1.0 |
| 34 | C3 | 8.6 | 63.7 |
| 35 | C3 | 8.6 | 46.1 |
| 36 | C9 | 5.4 | 76.4 |
| 37 | C9 | 6.4 | 63.8 |
| 38 | C7 | −187.2 | 0.1 |
| 39 | C9 | −197.6 | 66.6 |
| 40 | C9 | −196.5 | 86.7 |
| 41 | C9 | −197.5 | 99.3 |
| 42 | C3 | 11.2 | 133.3 |
| 43 | C10 | −46.4 | 5.5 |
| 44 | C9 | 9.1 | 97.8 |
| 45 | C9 | 9.1 | 115.7 |
| 46 | C9 | 6.5 | 46.1 |
| 47 | C9 | 6.5 | 28.2 |
| 48 | C10 | −139.0 | 4.5 |
| 49 | C9 | −197.5 | 134.9 |
| 50 | C9 | −197.5 | 116.9 |
| 51 | C9 | 8.0 | 146.0 |
| 52 | C9 | 9.1 | 133.4 |
| 53 | C10 | −138.6 | −4.1 |
| 54 | C10 | −46.6 | −5.0 |

In this exemplary application, the placement point assignment result PA and the placement sorting result PS obtained based on the time-optimal placement path optimization method provided by the invention are as follows:

$$PA = [ \begin{matrix}30 & 39 & 50 & 49 & 33 & 9 \\ 47 & 46 & 45 & 51 & 38 & 5 \\ 23 & 3 & 1 & 4 & 54 & 0 \\ 37 & 35 & 11 & 12 & 43 & 0 \\ 41 & 31 & 16 & 17 & 48 & 0 \\ 44 & 26 & 22 & 18 & 53 & 0 \\ 6 & 24 & 29 & 8 & 7 & 0 \\ 10 & 20 & 36 & 34 & 2 & 0 \\ 15 & 14 & 40 & 32 & 19 & 0 \\ 21 & 27 & 52 & 42 & 25 & 0 \\ 0 & 0 & 0 & 0 & 13 & 0 \\ 0 & 0 & 0 & 0 & 28 & 0\end{matrix} ] PS = [ \begin{matrix}4 & 3 & 2 & 1 & 5 & 6 \\ 1 & 2 & 3 & 4 & 6 & 5 \\ 5 & 1 & 2 & 3 & 4 & 0 \\ 1 & 2 & 3 & 4 & 5 & 0 \\ 1 & 2 & 3 & 4 & 5 & 0 \\ 4 & 1 & 2 & 3 & 5 & 0 \\ 1 & 5 & 2 & 3 & 4 & 0 \\ 1 & 2 & 3 & 4 & 5 & 0 \\ 5 & 1 & 2 & 3 & 4 & 0 \\ 1 & 2 & 3 & 4 & 5 & 0 \\ 5 & 0 & 0 & 0 & 0 & 0 \\ 5 & 0 & 0 & 0 & 0 & 0\end{matrix} ]$$

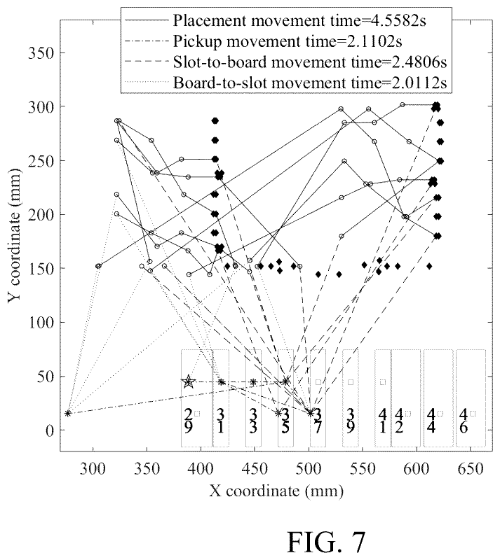

The placement path optimization result is shown in FIG. 7, the movement time of the carrier along a placement path obtained by the invention is TT₁=4.5582 s, and two approximate simultaneous placements are realized (the approximate simultaneous placements are indicated in bold in PA and PS).

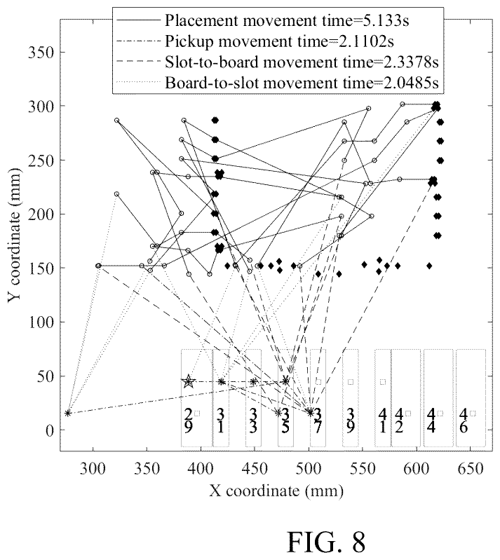

As a contrast, a placement path obtained by commercial software is shown in FIG. 8, the corresponding movement time is TT₀=5.133 s, and zero approximate simultaneous placement is realized. In this exemplary application, the invention shorts the SMT movement time by 100%*(TT₀−TT₁)/TT₀=11.2%. It thus can be seen that the invention is also suitable for placement path optimization in the assembly process of the circuit board adopting a hybrid layout and can effectively shorten the SMT movement time and improve the circuit board assembly efficiency of the surface mounter.

What is claimed is:

1. A time-optimal placement path optimization method for surface mounters, being suitable for assembling circuit boards adopting an array placement point arrangement, and comprising:
invoking a grid row grouping algorithm to classify placement points corresponding to a same type of components and having approximately the same Y-coordinate on a circuit board into one grid row; invoking a placement point assignment algorithm based on a progressive search rule to complete assignment of placement points corresponding to heads one by one, and constraining a search range of the assigned placement points to avoid a situation where one left placement head places components that are relatively to the right among the to-be-placed components, obtaining an initial placement point assignment result;
invoking a simultaneous placement point grouping algorithm to classify placement points, intervals between X-coordinates of which are approximately the same as intervals between the heads, in the grid rows into one simultaneous placement group; invoking a placement point assignment algorithm based on a simultaneous placement-maximized assignment rule to assign the placement points in the grid rows according to simultaneous placement groups to realize more minimum-distance simultaneous placement paths to decrease a length of short-distance movement paths so as to shorten a total time of a SMT movement process; assigning placement points that fail to form a simultaneous placement group in the grid rows according to the progressive search rule to obtain an initial placement point assignment result; and
comparing the initial placement point assignment results obtained by the two algorithms, selecting the one with a shorter total movement time, and allocating the placement points along the Y-axis between grid rows; based on a placement point assignment result, completing placement point assignment of remaining heads by means of a nearest insertion method, and obtaining a placement sequence of the heads by means of a farthest insertion method to obtain a placement path optimization result.

2. The time-optimal placement path optimization method for surface mounters according to claim 1, wherein
a specific process of invoking a grid row grouping algorithm to classify placement points corresponding to a same type of components and having approximately the same Y-coordinate on a circuit board into one grid row; invoking a placement point assignment algorithm based on a progressive search rule to complete assignment of placement points corresponding to heads one by one, and constraining a search range of the assigned placement points to avoid a situation where one left placement head places components that are relatively to the right among the to-be-placed components, obtaining an initial placement point assignment result comprises
Step 1, acquiring parameters of a surface mounter and production data of a circuit board;
Step 2, looping through all subcycles, and sequentially invoking, in each subcycle, the following algorithms to obtain a placement path optimization result;
Step 3, invoking the grid row grouping algorithm to classify placement points corresponding to the same type of components and having approximately the same Y-coordinate on the circuit board into one grid row; and
Step 5, invoking the placement point assignment algorithm based on the progressive search rule to complete assignment of placement point corresponding to the heads, and constraining the search range of the assigned placement points to avoid the situation where the heads on the left deviate from components on the right, thus obtaining the initial placement point assignment result;
a specific process of invoking a simultaneous placement point grouping algorithm to classify placement points, intervals between X-coordinates of which are approximately the same as intervals between heads, in the grid rows into one simultaneous placement group; 0028 invoking a placement point assignment algorithm based on a simultaneous placement-maximized assignment rule to assign the placement points in the grid rows according to simultaneous placement groups to realize more minimum-distance simultaneous placement paths to decrease an overall length of short-distance movement paths so as to shorten a total time of a SMT movement process; assigning placement points that fail to form a simultaneous placement group in the grid rows according to the progressive search rule to obtain an initial placement point assignment result comprises
Step 4, invoking the simultaneous placement point grouping algorithm to classify placement points, intervals between X-coordinates of which are approximately the same as intervals between heads, in the grid rows into one simultaneous placement group; and
Step 6, invoking the placement point assignment algorithm based on the simultaneous placement-maximized assignment rule to assign the placement points in the grid rows according to simultaneous placement groups to realize more minimum-distance simultaneous placement paths to decrease an overall length of short-distance movement paths so as to shorten the total time of a SMT movement process; assigning placement points that fail to form a simultaneous placement group in the grid rows according to the progressive search rule to obtain the initial placement point assignment result;
a specific process of comparing the initial placement point assignment results obtained by the two algorithms, selecting the one with a shorter total movement time, and allocating the placement points along the Y-axis between grid rows; based on a placement point assignment result, completing placement point assignment of remaining heads by means of a nearest insertion method, and obtaining a placement sequence of the heads by means of a farthest insertion method to obtain a placement path optimization result comprises:
Step 7, based on the placement point assignment result, completing placement point assignment of the remaining heads by means of the nearest insertion method, and obtaining the placement sequence of the heads by means of the farthest insertion method.

3. The time-optimal placement path optimization method for surface mounters according to claim 1, wherein a method for acquiring the parameters of the surface mounter and the production data of the circuit board comprises:
Step 11, importing the parameters of the surface mounter: the total number H of heads, index numbers hϵ[1, . . . , H] of the heads in an ascending order in the X-direction, intervals HDI between the heads, a movement speed VX of the surface mounter in the X-direction, and a movement speed VY of the surface mounter in the Y-direction; and
Step 12, acquiring the production data of the circuit board: component groups CPgin the pick-and-place cycles, the number SubcycleCPg of subcycles of the pick-and-place cycles, a first cycle floorCycle and a last cycle ceilCycle of each subycle, an X-coordinate CpTX and a Y-coordinate CpTY of the placement point corresponding to each component, serial numbers CpTNo of the placement points, the number numCpT of types of components to be placed on the circuit board, and the number numPTinCpT of placement points corresponding to each type of components, wherein the pick-and-place cycles corresponding to the same component groups form one subcycle, that is, in this embodiment.

4. The time-optimal placement path optimization method for surface mounters according to claim 3, wherein a method for sequentially invoking, in each subcycle, the following algorithms to obtain a placement path optimization result comprises:
Step 21, initializing parameters, wherein the parameters include the total number TotalCyc=sum(SubcycleCPg) of pick-and-place cycles, the number numCPg=numel(SubcycleCPg) of subcycles, an assignment result PA=zeros(TotalCyc, H) of placement points corresponding to heads, the thickness boundaryLayer=2 of a boundary layer of placement points classified into the same grid row, an array STcounter=cell(numCpT, 1) recording information about the number of points, capable of participating in simultaneous placement, in the grid rows corresponding to different types of components, and the number CPg1stCyc=floorCycle of the first pick-and-place cycle in each subcycle;
a numel function is used for acquiring the number of elements in an array, a zero function is used for initializing an all-0 matrix, a sum function is used for calculating the sum of values of all elements in an array, and a cell function is used for initializing a cell array;
Step 22, looping through all the subcycles:
Step 221, initializing a component group count variable cntCPg=1;
Step 222, determining whether cntCPg<numCPg; if so, initializing the serial number of a pick-and-place cycle that has completed placement point assignment, and performing Step 223; otherwise, performing Step 28;
Step 223, determining whether cyclast<ceilCycle(cntCPg); if so, performing Step 234; otherwise, updating cntCPg-cntCPg+1, and returning to Step 222;
Step 224, updating a temporary variable CpTX0=CpTX of CpTX, updating a temporary variable CpTY0=CpTY of CpTY, updating a temporary variableCpNo0=CpNo of CpNo, updating a component group temporary variable tmpCPg=CPg(cntCPg,:), acquiring index positions idxSame=find(tmpCPg==0) of non-assigned components in a component group, removing the non-assigned components from the component group tmpCPg(idxSame)=[ ], and saving the types of components in the component group in an array CPTinCPg;
wherein, a find function is used for searching for element indexes satisfying a condition in an array;
Step 225, determining whether tmpCPg is not empty; if so, performing Step 226;
otherwise, performing Step 227;
Step 226, updating CPTinCPg=[CPTinCPg tmpCPg(1)], acquiring indexes idxSame=find(tmpCPg==tmpCPg(1)) the same as tmpCPg(1), removing components tmpCPg(idxSame) corresponding to the indexes from the component group, and returning to Step 225;
Step 227, updating numCPTinCPg=numel(CPTinCPg), the types CPT_JL=CPTinCPg of components assigned according to the progressive search rule, and the number numCPT_JL=numCPTinCPg of components in the component group, initializing an array Head2CPT=cell(numCpT,1) of head numbers corresponding to each type of components, initializing an array numHd2CpTs=zeros(numCpT,1) of the number of heads corresponding to each type of components, and initializing a component type count variable cntCpT=1;
Step 228, determining whether cntCpT<numCPTinCPg; if so, performing Step 229; otherwise, performing Step 231;
Step 229, updating a component type index idxCpT=CPTinCPg(cntCpT), acquiring Head2CPT0{idxCpT,1}=find(CPg(cntCPg,:)==idxCpT), updating numHd2CpTs(idxCpT)=numel(Head2CPT0{idxCpT,1}), updating Head2CPT{idxCpT,1}=Head2CPT0{idxCpT,1}(numHd2CpTs(idxCpT):−1:1), updatingcntCpT=cntCpT+1, and returning to Step 228;
Step 231, according to pTX0, CpTY0, CpNo0, boundaryLayer, CPT_JL, numCPT_JL and numHd2CpTs, invoking the grid row grouping algorithm in Step 3 to obtain PTAGroup, LengthPTAG, PtArrayX, PtArrayN and StorePTAG_R;
wherein, PTAGroup is a grid row group;
LengthPTAG is a length storage array in the grid row group;
a grid row placement point information recoding array PtArrayX records X-coordinates of the placement points in the grid rows;
a grid row placement point information recoding array PtArrayN records the serial numbers of the placement points in the grid rows;
StorePTAG_R is a count index of the grid rows from right to left;
Step 232, initializing tmpCPg-ones(1, H), acquiring indexes idx0=find(CPg(cntCPg,:)==0) of heads, to which components are not allocated, in the component group, updating tmpCPg(idx0)=tmpCPg(idx0)*0, initializing grid row group usage information usedPTAGinfo=cell(2,1) and all available heads usedHDs in the current component group, and initializing the component type count variable cntCpT=1, wherein a ones function is used for generating an all-1 matrix;
Step 233, determining whether cntCpT<numCPT_JL; if so, performing Step 234; otherwise, performing Step 235;
Step 234, acquiring the component type index idxCpT=CPT_JL(cntCpT), updating tmpCPg(Head2CPT{idxCpT,1})=tmpCPg(Head2CPT{idxCpT,1})*cntCpT, updating usedPTAGinfo{1,1}=[usedPTAGinfo{1,1}[idxCpT; 1]], updating usedPTAGinfo{2,1}{cntCpT}=StorePTAG_R{idxCpT}{1}, updating usedHDs=[usedHDs Head2CPT{idxCpT,1}], updating cntCpT=cntCpT+1, and returning to Step 233;
Step 235, sorting the heads in a descending order usedHDs=sort(usedHDs,‘descend’), acquiring the number numHDs=numel(usedHDs) of used heads, initializing a minimum number mincyc=SubcycleCPg(cntCPg)−(CPg1stCyc(cntCPg)−floorCycle(cntCPg)) of completion cycles of the grid rows, and initializing cntCpT=1, wherein a sort function is used for sorting elements in an array according to values of the elements and returning an index sequence obtained after sorting, and “descend” refers to sorting in a descending order;
Step 236, determining whether cntCpT<numCPT_JL; if so, performing Step 237; otherwise, performing Step 238;
Step 237, acquiring the component type index idxCpT=CPT_JL(cntCpT), acquiring the lengthnumPTinPTA4=LengthPTAG{idxCpT,1}(1) of the grid rows, acquiring the number numHd=numHd2CpTs(idxCpT) of heads corresponding to current components, acquiring the minimum number mincyc1=floor(numPTinPTA4/numHd) of completion cycles of the grid rows corresponding to the current components, and determining whether mincyc>mincyc1; if so, updating mincyc=mincyc1; otherwise, updating cntCpT=cntCpT+1, and returning to Step 236;
Step 238, initializing a “placement point-head pair” information storage array SeqPTAX=cell(mincyc, H) and a corresponding temporary variable SeqPTAX0=SeqPTAX;
initializing a minimum time TMin_PTAG=inf of grid row-based assignment; acquiring indexes idx0s=find(CPT_JL==0) of elements 0 in CPT_JL, and deleting the indexes CPT_JL(idx0s)=[ ]; sorting the numbers of heads used for different types of components in the current component group in a descending order [˜,idxsort]=sort(numHd2CpTs(CPT_JL), ‘descend’), CPT_JL-CPT_JL(idxsort);
initializing the number numPTA=zeros(1,numCPT_JL) of grid rows in the first grid row group of each type of components, wherein numCPT_JL=numel(CPT_JL);
initializing the component type count variable cntCpT=1; and
Step 239, determining whether cntCpT<numCPT_JL; if so, acquiring the component type index idxCpT=CPT_JL(cntCpT), initializingSTcounter{idxCpT,1}{1,1}=zeros(1,LengthPTAG{idxCpT,1}(1)), and initializing STcounter{idxCpT,1}{1,2}=cell(1,LengthPTAG{idxCpT,1}(1)), wherein:
STcounter is used for counting simultaneous placements realized by points in an ideal grid row corresponding to the current component group LengthPTAG; updating numPTA(cntCpT)=size(PTAGroup{idxCpT}{1},2), updating cntCpT=cntCpT+1, and returning to Step 239; otherwise, performing Step 24;
Step 24, according to numPTA, PtArrayX, PTAGroup, LengthPTAG, numHd2CpTs, Head2CPT, STcounter, boundaryLayer, CPT_JL and numCPT_JL, invoking the simultaneous placement point grouping algorithm in Step 4 to obtain an approximate simultaneous placement information storage array STMatchInfo and the array STcounter recording information about the number of points, capable of participating in simultaneous placement, in the grid rows corresponding to different types of components;
Step 25, with the realization of maximum simultaneous placements as a main objective, assigning the placement points in the grid rows, comprising:
Step 251, initializing a flag flag1stPT=1 indicting the presence of assigned points, initializing a predicted placement time of each cycle TinCycs_Mix=zeros(1,mincyc), initializing a temporary variable UPTAGI_Mix=usedPTAGinfo of usedPTAGinfo, initializing a temporary variable SeqPTA_Mix=SeqPTAX of SeqPTAX, and initializing a cycle count variable cntmc=1;
Step 252, determining whether cntmc<=mincyc; if so, simultaneously performing Step 253 and Step 254; otherwise, performing Step 258;
Step 253, initializing a no-simultaneous placement storage array NoSTHDs=[ ], ST_UHD0=NOSTHDs, usedPTAGinfo=UPTAGI_Mix, SeqPTA=SeqPTA_Mix, and according to cntmc, usedPTAGinfo, SeqPTA, usedHDs, tmpCPg, PtArrayX, STcounter, STMatchInfo, mincyc, ST_UHD0, PTAGroup and flag1stPT, invoking the placement point assignment algorithm based on the progressive search rule in Step 5 to obtain an initial assignment result of a placement point-head pair: grid row group usage information usedPTAGinfo, an assignment condition SeqPTA of the current “placement point-head pair”, and a movement time TinCYC in the current cycle; updating usedPTAGinfo2=usedPTAGinfo, updatingSeqPTA2=SeqPTA, updating T_PTAinCYC=TinCYC, and performing Step 256;
Step 254, usedPTAGinfo=UPTAGI_Mix, SeqPTA=SeqPTA_Mixm numCPTinCPg=numCPT_JL; according to cntmc, usedPTAGinfo, SeqPTA, usedHDs, tmpCPg, PtArrayX, STcounter, STMatchInfo, numCPTinCPg and PTAGroup, invoking the placement point assignment algorithm based on the simultaneous placement-maximized assignment rule in Step 6 to obtain an initial assignment result of the placement point-head pair: grid row group usage information usedPTAGinfo, the assignment condition SeqPTA of the current “placement point-head pair” and the indexes ST_UHD of heads capable of realizing simultaneous placement; performing Step 255;
Step 255, updating ST_UHD0=ST_UHD; according to cntmc, usedPTAGinfo, SeqPTA, usedHDs, tmpCPg, PtArrayX, STcounter, STMatchInfo, mincyc, ST_UHD0, PTAGroup and flag1stPT, invoking the placement point assignment algorithm based on the progressive search rule in Step 5 to obtain an initial assignment result of a placement point-head pair: grid row group usage information usedPTAGinfo, the assignment condition SeqPTA of the current “placement point-head pair” and the movement time TinCYC in the current cycle; updating usedPTAGinfo0_1=usedPTAGinfo, updating SeqPTA0_1=SeqPTA, updating T_PTAinCYC0_1=TinCYC, and performing Step 256;
Step 256, determining whether T_PTAinCYC<T_PTAinCYC0_1; if so, updating SeqPTA_Mix=SeqPTA2, updating UPTAGI_Mix=usedPTAGinfo2, and updating TinCycs_Mix (cntmc)=T_PTAinCYC; otherwise, updating SeqPTA_Mix=SeqPTA0_1, updating UPTAGI_Mix=usedPTAGinfo0_1, and updating TinCycs_Mix (cntmc)=T_PTAinCYC0_1;
Step 257, updating cntmc=cntmc+1, and returning to Step 252;
Step 258, obtaining a total cycle time TSum_Mix=sum(TinCycs_Mix); and
Step 259, determining whether TMin_PTAG>TSum_Mix; if so, updating TMin_PTAG=TSum_Mix, and updating SeqPTAX=SeqPTA_Mix;
Step 26, performing matching of the grid rows in the Y-direction:
Step 261, acquiring the number numUsedPTA=min([numPTA of used grid rows, floor(SubcycleCPg(cntCPg)/mincyc)]), initializing a grid row sequence SeqPTAY=zeros(numUsedPTA,numCPT_JL) in the Y-direction, and initializing the component type count variable cntCpT=1, wherein a min function is used for acquiring a minimum value of elements in an array;
Step 262, determining whether cntCpT<numCPT_JL; if so, updating SeqPTAY(:,cntCpT)=1:numUsedPTA, updating cntCpT=cntCpT+1, and returning to Step 262;
Step 263, initializing a temporary variable preOCP=PA of PA, and initializing cntUPTA=1;
Step 264, determining whether cntUPTA<numUsedPTA; if so, performing Step 256; otherwise, performing Step 27;
Step 265, determining whether mincyc is not 0; if so, acquiring a first cycle cycfirst=CPg1stCyc(cntCPg)+(cntUPTA−1)*mincyc, acquiring a last cycle cyclast=min([CPg1stCyc(cntCPg)+cntUPTA*mincyc−1, ceilCycle(cntCPg)]), and initializing a cycle count variable cntcyc=cycfirst; otherwise, updating cntUPTA=cntUPTA+1, and returning to Step 264;
Step 266, determining whether cntcyc<cyclast; if so, initializing the component type count variable cntCpT=1, and performing Step 267; otherwise, updating cntUPTA=cntUPTA+1, and returning to Step 264;
Step 267, determining whether cntCpT<numCPT_JL; if so, acquiring idxCpT-CPT_JL(cntCpT), initializing a head count variable cntHd=1, and performing Step 268; otherwise, updating cntcyc=cntcyc+1, and returning to Step 266;
Step 268, determining whether cntHd<numHd2CpTs(idxCpT); if so, acquiring a head index idxHd=Head2CPT{idxCpT,1}(cntHd), and acquiring corresponding cycles in SeqPTAX; otherwise, updating cntCpT=cntCpT+1, and returning to Step 267;
Step 269, determining whether SeqPTAX{idxcyc,idxHd} is empty; if so, acquiring idxPTinArray=SeqPTAX{idxcyc,idxHd}(3), acquiring idxPTAG=SeqPTAX{idxcyc,idxHd}(2), acquiring cntPTA=SeqPTAY(cntUPTA,cntCpT), acquiringidxPTA=PTAGroup{idxCpT}{idxPTAG}(1,cntPTA), and updating preOCP(cntcyc,idxHd)=PtArrayN{idxCpT,idxPTA}(idxPTinArray); updating cntHd=cntHd+1, and returning to Step 268;
Step 27, performing Step 7, matching remaining non-assigned placement points by means of the nearest insertion method, updating CPg1stCyc(cntCPg)=cyclast+1, updating PA=BestOCP, updating numPTinCpT=BestnumPT, and returning to Step 223; and
Step 28, outputting a placement path optimization result.

5. The time-optimal placement path optimization method for surface mounters according to claim 4, wherein the grid row grouping algorithm comprises:
Step 31, initializing parameters, wherein the parameters include: grid row placement point information recording arrays PtArrayX, PtArrayY and PtArrayN, grid row groups PTAGroup, length storage arrays LengthPTAG in the grid row groups, an array L0ArrayX of the distance from each point in each grid row to the first point, count indexes StorePTAG_R of the grid rows from right to left, and the number numPTAGinCpt of grid rows corresponding to each type of components;
the grid row placement point information recording array PtArrayY is used for recording Y-coordinates of the placement points in the grid rows;
the grid row groups PTAGroup are used for storing grouping information of different dot matrix rows corresponding to different components;
Step 32, initializing the component type count variable cntCpT=1;
Step 33, determining whether cntCpT<numCPT_JL; if so, performing Step 34; otherwise, performing Step 36;
Step 34, updating a current component type index idxCpT-CPT_JL(cntCpT), and updating the thickness boundaryLayer of the boundary layer;
Step 35, classifying current component placement points into different grid rows;
Step 351, initializing a grid row group temporary variable PTAGroup0{idxCpT,1}=[ ]; initializing the length storage array lenPTAG; assigning X-coordinates, Y-coordinates and numbers of the placement points CpTY1=CpTY0, CpTX1=CpTX0 and CpNo1=CpNo0; assigning the grid row placement point information recording arrays PtArrayX_1=PtArrayX, PtArrayY_1=PtArrayY and PtArrayN_1=PtArrayN; initializing a grid row group count variable numPTAG=0; initializing a grid row count variable cntPtArray=0;
Step 352, determining whether CpTY1{idxCpT} is not empty; if so, performing Step 353; otherwise, performing Step 357;
Step 353, updating cntPtArray=cntPtArray+1; acquiring indexes idxSameArray=find(abs(CpTY1{idxCpT}=CpTY1{idxCpT}(1))<boundaryLayer) of placement points, the distance from Y-coordinates of which to CpTY1{idxCpT}(1) is less than the thickness of the boundary layer, corresponding to the current components; updating the placement points satisfying the condition into the grid row placement point information recording arrays PtArrayX_1{idxCpT,cntPtArray}=CpTX1{idxCpT}(idxSameArray), PtArrayY_1{idxCpT,cntPtArray}=CpTY1{idxCpT}(idxSameArray) and PtArrayN_1{idxCpT,cntPtArray}=CpNo1{idxCpT}(idxSameArray);
Step 354, sorting grid row placement point information according to the Y-coordinates, wherein [PtArrayX_1{idxCpT,cntPtArray},idxPAXsort]=sort(PtArrayX_1{idxCpT,cntPtArray}), idxPAXsort is placement point index information obtained after sorting; PtArrayX_1{idxCpT,cntPtArray}=PtArrayX_1{idxCpT,cntPtArray}(idxPAXsort), PtArrayY_1{idxCpT,cntPtArray}=PtArrayY_1{idxCpT,cntPtArray}(idxPAXsort), PtArrayN_1{idxCpT,cntPtArray}=PtArrayN_1{idxCpT,cntPtArray}(idxPAXsort); removing extracted placement points to avoid secondary assignment; CpTX1{idxCpT}(idxSameArray)=[ ], CpTY1{idxCpT}(idxSameArray)=[ ], CpNo1{idxCpT}(idxSameArray)=[ ]; calculating lengths numPTinAG=numel(PtArrayX_1{idxCpT,cntPtArray}) of extracted grid rows;
Step 355, determining whether numPTAG>0; if so, performing Step 36; otherwise, performing Step 356;
Step 356, updating numPTAG=1; calculating the distance from each point in the grid row to the first point L0ArrayX{idxCpT,cntPtArray}=PtArrayX_1{idxCpT,cntPtArray}-PtArrayX_1{idxCpT,cntPtArray}(1); recording the length lenPTAG=[lenPTAG numPTinAG] of grid rows in the current grid row group; updating the grid row group information PTAGroup0{idxCpT,1}{numPTAG}=[cntPtArray;sum(PtArrayY_1{idxCpT,cntPtArray})/numPTinAG]; returning to Step 352;
Step 357, determining whether max (lenPTAG)>=numHd2CpTs(idxCpT); if so, performing Step 37; otherwise, performing Step 358; and
Step 358, increasing the thickness of the boundary layer boundaryLayer=boundaryLayer+2 to ensure that the length of the grid rows corresponding to the components at least satisfies the requirement of one cycle; returning to Step 351;
Step 36, looping through grid row groups that have completed assignment, and determining whether the current grid row belongs to an existing grid row group:
Step 361, initializing the grid row group count variable cntPTAG=1;
Step 362, determining whether cntPTAG<numPTAG; if so, performing Step 363; otherwise, returning to Step 352;
Step 363, acquiring an index idxPTA=PTAGroup0{idxCpT,1}{cntPTAG}(1) of the first grid row in the (cntPTAG)^{th} group;
Step 364, determining whether lenPTAG(cntPTAG)==numPTinAG; if so, performing Step 365; otherwise, performing Step 368;
Step 365, determining whether the X-axis coordinates of the first placement points in the currently extracted grid row and in historically stored grid rows are close abs(PtArrayX_1{idxCpT,cntPtArray}(1)−PtArrayX_1{idxCpT,idxPTA}(1))<boundaryLayer; if so, performing Step 366; otherwise, performing Step 368, wherein an abs function is used for acquiring an absolute value of an element;
Step 366, calculating the distance from each point in the grid row to the first point L0ArrayX{idxCpT,cntPtArray}=PtArrayX_1{idxCpT,cntPtArray}−PtArrayX_1{idxCpT,cntPtArray}(1); determining whether sum(abs(L0ArrayX{idxCpT,cntPtArray}−L0ArrayX{idxCpT,idxPTA}))/numPTinAG<boundaryLayer; if so, performing Step 367; otherwise, performing Step 368;
Step 367, updating the grid row group information PTAGroup0{idxCpT,1}{cntPTAG}=[PTAGroup0{idxCpT,1}{cntPTAG}[cntPtArray;sum(PtArrayY_1{idxCpT,cntPtArray})/numPTinAG]], and returning to Step 352;
Step 368, determining whether cntPTAG==numPTAG; if so, performing Step 369;
otherwise, updating cntPTAG=cntPTAG+1, and returning to Step 361; and
Step 369, updating numPTAG=numPTAG+1, updating lenPTAG=[lenPTAG numPTinAG], updating PTAGroup0{idxCpT,1}{numPTAG}=[cntPtArray;sum(PtArrayY_1{idxCpT,cntPtArray})/numPTinAG], and returning to Step 352;
Step 37, updating PtArrayX=PtArrayX_1, updating PtArrayY=PtArrayY_1, updating PtArrayN=PtArrayN_1, updating the grid row lengthsLengthPTAG{idxCpT,1}=lenPTAG in the grid row groups corresponding to the current components, updating cntCpT=cntCpT+1, and returning to Step 33;
Step 38, performing postprocessing on grid row data:
Step 381, initializing the component type count variable cntCpT=1;
Step 382, determining whether cntCpT<numCPT_JL; if so, performing Step 383; otherwise, performing Step 39;
Step 383, updating the component type index idxCpT=CPT_JL(cntCpT); sorting the grid row lengths corresponding to the current components in a descending order to ensure the assignment priority of long dot matrix rows [LengthPTAG{idxCpT,1},idxLSort]=sort(LengthPTAG{idxCpT,1},‘descend’); acquiring the number numPTAGinCpt (idxCpT)=numel(idxLSort) of grid row groups corresponding to the current components;
Step 384, initializing the grid row group count variable cntPTAGinCPT=1;
Step 385, determining whether cntPTAGinCPT<numPTAGinCpt (idxCpT); if so, performing Step 386; otherwise, updating cntCpT=cntCpT+1; returning to Step 382; and
Step 386, updating the grid row group information according to a grid row length sorting result PTAGroup{idxCpT,1}{cntPTAGinCPT}=PTAGroup0{idxCpT,1}{idxLSort (cntPTAGinCPT)}; acquiring the number numPTinPTA=LengthPTAG{idxCpT,1}(cntPTAGinCPT) of placement points in the longest grid row; updating StorePTAG_R{idxCpT}{cntPTAGinCPT}=numPTinPTA:−1:1; updating cntPTAGinCPT=cntPTAGinCPT+1; returning to Step 385, wherein num:−1:1 indicates the generation of a sequence from num to 1 in a descending order; and
Step 39, returning PTAGroup, LengthPTAG, PtArrayX, PtArrayN and StorePTAG_R, and returning to Step 232.

6. The time-optimal placement path optimization method for surface mounters according to claim 3, wherein the simultaneous placement point grouping algorithm comprises:
Step 41, initializing parameters, wherein the parameters include: an array STYMem=[ ] storing information of components with the same Y-coordinate, the number numSTM=0 of combinations in STYMem, and STMatchInfo=cell(1,3);
Step 42, looping through all component types, and performing assignment with a current component as a main component:
Step 421, initializing the component type count variable cntCpT=1, and initializing a longest grid row index of each type of components idxPTAGinCPT=1; and
Step 422, determining whether cntCpT<numCPT_JL; if so, performing Step 43; otherwise, performing Step 49;
Step 43, looping through grid rows in the current grid row group:
Step 431, initializing the grid row count variable cntPTA=1;
Step 432, determining whether cntPTA<numPTA(cntCpT); if so, performing Step 433;
otherwise, updating cntCpT=cntCpT+1, and returning to Step 422;
Step 433, acquiring a Y-coordinate PTAY=PTAGroup{idxCpT}{idxPTAGinCPT}(2,cntPTA) of the current grid row, and updating STYMem=[idxCpT;idxPTAGinCPT;cntPTA];
Step 434, initializing a temporary component type count variable cntCpT1=1;
Step 435, determining whether cntCpT1<numCPT_JL; if so, performing Step 436;
otherwise, performing Step 44;
Step 436, determining whether cntCpT1 is not equal to cntCpT; if so, performing Step 437; otherwise, updating cntCpT1=cntCpT1+1, and returning to Step 435;
Step 437, acquiring a temporary component index idxCpT1=CPT_JL(cntCpT1), and acquiring indexes idxSameY=find(abs(PTAGroup{idxCpT1}{cntPTAGinCPT1}(2,:)−PTAY)<boundaryLayer, 1) of grid rows, the distance between Y-coordinates of which and the Y-coordinate of the grid row group corresponding to the main component is less than the boundary layer, in the grid row group corresponding to a temporary component;
Step 438, determining whether numel(idxSameY)>0; if so, performing Step 439; otherwise, updating cntCpT1=cntCpT1+1, and returning to Step 435; and
Step 439, updating cntCpT1=cntCpT1+1, updating STYMem=[STYMem [idxCpT1;cntPTAGinCPT1;idxSameY]], and returning to Step 435;
Step 44, looping through existing co-Y-axis grid row combinations, and determining whether assignment has been completed:
Step 441, initializing a co-Y-axis grid row exist flag flagExistY=0, initializing the number numCPTemp=size(STYMem,2) of each type of components in STYMem, and initializing the count variable cntSTM=1 of STYMem;
Step 442, determining whether cntSTM<numSTM; if so, performing Step 443; otherwise, performing Step 446;
Step 443, acquiring the number numCPTinSYM=size(STMatchInfo{cntSTM,1},2) of types of components assigned to the co-Y-axis grid row combinations;
Step 444, determining whether numCPTinSYM is equal to numCPTemp; if so, performing Step 445; otherwise, updating cntSTM=cntSTM+1, and returning to Step 442;
Step 445, determining whether STMatchInfo{cntSTM,1}(1:2,:) is equal to STYMem(1:2,:); if so, updating flagExistY=1, and performing Step 446; otherwise, updating cntSTM=cntSTM+1, and returning to Step 442;
Step 446, determining whether flagExistY is not 0; if so, performing Step 447; otherwise, performing Step 448;
Step 447, updating grid row numbers STMatchInfo{cntSTM,3}=[STMatchInfo{cntSTM,3};STYMem(3,:)] correspondingly recorded in STMatchInfo; updating cntPTA=cntPTA+1, and returning to Step 431; and
Step 448, updating numSTM=numSTM+1; updating STMatchInfo{numSTM,1}=STYMem(1:2,:); updating STMatchInfo{numSTM,3}=STYMem(3,:), and performing Step 45;
Step 45, performing point pair information matching in the X-direction:
Step 451, initializing parameters, wherein the parameters include: an X-direction point pair information storage array STXMem=cell(1,2), the number numSTXM of STXMem, component indexesidxCpT2=STYMem(1,1) of main components in STYMem, grid row groups cntPTAGinCPT2=STYMem(2,1) used by a co-Y-axis grid row group formed by the main components, grid rows cntPTA2=STYMem(3,1) used by the grid row group, grid row indexes idxPtArray2=PTAGroup{idxCpT2}{cntPTAGinCPT2}(1,cntPTA2) used by the main components idxCpT2, grid a row length numPTinPTA2=LengthPTAG{idxCpT2,1}(cntPTAGinCPT2) used by the main components idxCpT2, all head indexes idxHDs2=Head2CPT{idxCpT2,1} corresponding to the main components idxCpT2, the number numHD2=numHd2CpTs(idxCpT2) of heads corresponding to the main components idxCpT2, and a count variable cntHD2=1 of the heads corresponding to the main components;
Step 452, determining whether cntHD2<numHD2; if so, performing Step 453; otherwise, performing Step 48;
Step 453, updating a current head index idxHd2=idxHDs2(cntHD2), and initializing a placement point count variable cntPT2=1 of the current grid row;
Step 454, determining whether cntPT2<numPTinPTA2; if so, performing Step 455; otherwise, updating cntHD2=cntHD2+1, and returning to Step 452; and
Step 455, acquiring a current X-coordinate X2=PtArrayX{idxCpT2, idxPtArray2}(cntPT2), and performing Step 46;
Step 46, at current head positions, checking whether heads where the other components are located correspond to simultaneous placement points:
Step 461, defining the other components other than the main component as secondary components, and initializing a secondary component count variable cntCpT3=1;
Step 462, determining whether cntCpT3<numCPTemp; if so, performing Step 463; otherwise, performing Step 47;
Step 463, acquiring component indexes idxCpT3=STYMem(1,cntCpT3) of secondary components in STYMem, the grid row group cntPTAGinCPT3=STYMem(2,cntCpT3) used as co-Y-axis grid row groups formed by the secondary components, the grid rows cntPTA3=STYMem(3,cntCpT3) used in the grid row groups, grid row indexes idxPtArray3=PTAGroup{idxCpT3}{cntPTAGinCPT3}(1,cntPTA3) used by the components, secondary all head indexes idxHDs3=Head2CPT{idxCpT3,1} corresponding to the secondary components idxCpT3, the number of the heads numHD3=numHd2CpTs(idxCpT3) corresponding to the secondary components idxCpT3, and a temporary variable tmpSTXMem=[idxHd2; cntPT2;cntPTAGinCPT2;idxCpT2] of STXMem;
Step 464, initializing a count variable cntHD3=1 of the heads corresponding to the secondary components;
Step 465, determining whether cntHD3<numHD3; if so, performing Step 466; otherwise, updating cntCpT3=cntCpT3+1, and returning to Step 462;
Step 466, acquiring the indexes idxHd3=idxHDs3(cntHD3) of the heads corresponding to the secondary components; determining whether idxHd3<=idxHd2; if so, updating cntHD3=cntHD3+1, and returning to Step 465; otherwise, performing Step 467;
Step 467, acquiring all X-coordinates Xs3=PtArrayX{idxCpT3, idxPtArray3} of grid rows corresponding to the secondary components; converting coordinates X2 into X-coordinates X2_3=X2+(idxHd3−idxHd2)*HDI of the heads corresponding to the secondary components; acquiring indexes idxSame=find(abs(Xs3−X2_3)<boundaryLayer,1) of placement points corresponding to the coordinates Xs3 having a distance to the coordinates X2_3 less than boundaryLayer; and
Step 468, determining whether numel(idxSame) is not 0; if so, updating tmpSTXMem=[tmpSTXMem[idxHd3;idxSame;cntPTAGinCPT3;idxCpT3]]; otherwise, updating cntHD3=cntHD3+1, and returning to Step 465;
Step 47, looping through all simultaneous placement point combinations, and determining whether assignment of the simultaneous placement point combinations has been completed:
Step 471, sorting tmpSTXMem according to the heads [˜,idxsort]=sort(tmpSTXMem(1,:),‘descend’), tmpSTXMem=tmpSTXMem(:,idxsort), initializing an assigned simultaneous placement point flags flagExistX=0, and acquiring the number numPTemp=size(tmpSTXMem,2) of head indexes stored in tmpSTXMem;
Step 472, determining whether numPTemp>1; if so, acquiring a leftmost head index LeftHd=min(tmpSTXMem(1,:)) in tmpSTXMem, aligning all head indexes in tmpSTXMem with LeftHd as a reference tmpSTXMem(1,:)=tmpSTXMem(1,:)−LeftHd+1, initializing a STXMem count variable cntSTXMem=1, and performing Step 473; otherwise, updating cntPT2=cntPT2+1, and returning to Step 454;
Step 473, determining whether cntSTXMem<numSTXM; if so, performing Step 474; otherwise, performing Step 475;
Step 474, acquiring information numPTinSTXM=size(STXMem{cntSTXMem,1},2) of the number of (cntSTXMem)^{th} assigned placement points; determining whether numPTinSTXM is equal to numPTemp and STXMem{cntSTXMem,1} is equal to tmpSTXMem; if so, updating flagExistX=1, and performing Step 475; otherwise, updating cntSTXMem=cntSTXMem+1, and returning to Step 473;
Step 475, determining whether flagExistX is not 0; if so, performing Step 476; otherwise, performing Step 477;
Step 476, searching STXMem{cntSTXMem,2} for indexes the same as LeftHd:idxSame1=find(STXMem{cntSTXMem,2}==LeftHd); if idxSame1 is empty, updating STXMem{cntSTXMem,2}=[STXMem{cntSTXMem,2};LeftHd]; updatingcntPT2=cntPT2+1, and returning to Step 454;
Step 477, updating numSTXM=numSTXM+1, updating STXMem{numSTXM,1}=tmpSTXMem, updating STXMem{numSTXM,2}=LeftHd, and initializing the placement point count variable cntPTemp=1;
Step 478, determining whether cntPTemp<numPTemp; if so, performing Step 479; otherwise, updatingcntPT2=cntPT2+1, and returning to Step 454; and
Step 479, acquiring a temporary component type index idxCpt0=tmpSTXMem(4,cntPTemp) and a temporary placement point index idxPTinPTA0=tmpSTXMem(2,cntPTemp); updating STcounter{idxCpt0,1}{1,1}(idxPTinPTA0)=STcounter{idxCpt0,1}{1,1}(idxPTinPTA0)+1; updating STcounter{idxCpt0,1}{1,2}{idxPTinPTA0}=[STcounter{idxCpt0,1}{1,2}{idxPTinPTA0}; [numSTM numSTXM numPTemp]]; updating cntPTemp=cntPTemp+1, and returning to Step 478;
Step 48, storing STXMem in STMatchInfo: STMatchInfo{numSTM,2}=STXMem; updating cntPTA=cntPTA+1, and returning to Step 432; and
Step 49, sorting the numbers of placement points participating in simultaneous placement:
Step 491, acquiring the number numSTcounter=size(STcounter,1) of STcounter, and initializing a count variable cntSTC=1 of STcounter;
Step 492, determining whether cntSTC<numSTcounter; if so, performing Step 493; otherwise, performing Step 497;
Step 493, determining whether STcounter{cntSTC,1} is empty; if so, performing Step 494; otherwise, updating cntSTC=cntSTC+1, and returning to Step 492;
Step 494, acquiring a simultaneous placement length lengthCounter=numel(STcounter{cntSTC,1}{1,1}), and initializing a simultaneous placement length count variable cntLC=1;
Step 495, determining whether cntLC<lengthCounter; if so, performing Step 496; otherwise, updating cntSTC=cntSTC+1, and returning to Step 492;
Step 496, determining whether STcounter{cntSTC,1}{1,2}{cntLC} is not empty; if so, sorting according to the number of simultaneous placements [˜,idxsort]=sort(STcounter{cntSTC,1}{1,2}{cntLC}(:,3),‘descend’), updating STcounter{cntSTC,1}{1,2}{cntLC}=STcounter{cntSTC,1}{1,2}{cntLC}(idxsort,:) according to a sorting result, updating cntLC=cntLC+1, and returning to step 495; otherwise, updating cntLC=cntLC+1, and returning to Step 495; and
Step 497, returning STMatchInfo and STcounter, and returning to Step 25.

7. The time-optimal placement path optimization method for surface mounters according to claim 4, wherein the placement point assignment algorithm based on the progressive search rule comprises:
Step 51, performing parameter initialization and head preprocessing:
Step 511, initializing parameters, wherein the parameters include: indexes ST_UHD=[ ] of heads capable of realizing “simultaneous placement” in usedHDs, the number numHD of heads in usedHDs, heads flagSTC1=zeros(numHDs,1) capable of realizing simultaneous placement, heads flagSC=ones(numHDs,1) that have not completed assignment, heads flagSC0=ones(numHDs,1) that have not been subjected to simultaneous placement, a path recording array WaypointX=zeros(1,numHDs1), a placement point-head pair information storage array SeqPTAX, an information storage array RecordX=zeros(1,numHDs) of X-coordinates of placement points corresponding to the heads, and simultaneous heads ST_UHD0 that have been assigned; and
Step 512, head preprocessing: setting a temporary variable usedHDs1=usedHDs of usedHDs, a temporary variable numHDs1=numel(usedHDs1) of numHDs, removing assigned heads usedHDs(ST_UHD0)=[ ] from usedHDs, and updating numHDs=numel(usedHDs);
Step 52 comprising:
Step 521, determining whether sum(flagSC) is not zero; if so, acquiring non-zero coordinate indexes idxnon0=find(WaypointX˜=0) in WaypointX; determining whether flag1stPT is not zero; if so, flagEmpty=idxnon0; otherwise, flagEmpty=[ ]; otherwise, performing Step 58;
Step 522, determining whether flagEmpty is empty; if so, performing Step 522; otherwise, performing Step 524;
Step 523, acquiring idxHD=usedHDs(1), acquiring cntCPt=tmpCPg(idxHD), idxCpT=usedPTAGinfo{1,1}(1,cntCPt), acquiring acquiring idxPTAG=usedPTAGinfo{1,1}(2,cntCPt), acquiring idxPtArray=PTAGroup{idxCpT}{idxPTAG}(1,1), acquiring idxPTinArray=usedPTAGinfo{2,1}{cntCPt}(1), recoding “placement point-head pair” information SeqPTA{cntmc,idxHD}=[idxCpT; idxPTAG;idxPTinArray], removing assigned placement points to prevent secondary assignment usedPTAGinfo{2,1}{cntCPt}(1)=[ ], acquiring the X-coordinate CurrentX=PtArrayX{idxCpT, idxPtArray}(idxPTinArray) of the current assigned point, updating RecordX(1)=CurrentX, updatingflagSC(1)=0, and performing Step 54; and
Step 524, performing assignment under the precondition where assignment of existing heads has been completed, acquiring a non-zero maximum value max WPX=max (WaypointX(idxnon0)) in WaypointX, updating idxHDs=find(WaypointX==max WPX), updating idxHD=idxHDs(end), updating idxCpT=SeqPTA{cntmc,idxHD}(1), updating idxPTAG=SeqPTA{cntmc,idxHD}(2); updating idxPtArray=PTAGroup{idxCpT}{idxPTAG}(1,1), updating idxPTinArray=SeqPTA{cntmc,idxHD}(3), acquiring CurrentX=PtArrayX{idxCpT, idxPtArray}(idxPTinArray); updating flagSC(1)=0, and performing Step 53;
Step 53, determining groups of remaining points in the grid rows according to the progressive search rule:
Step 531, acquiring a head index idxHD0=HD2CPT(cntHDs); acquiring an ideal placement position nextHdX=CurrentX−(idxHD−idxHD0)*HDI of idxHD0 with respect to the previous assigned head, wherein idxHD is the index of the previous assigned head; acquiring cntCPt=tmpCPg(idxHD0); acquiringidxCpT=usedPTAGinfo{1,1}(1,cntCPt); acquiring idxPTAG=usedPTAGinfo{1,1}(2,cntCPt); acquiring idxPtArray=PTAGroup{idxCpT}{idxPTAG}(1,1); acquiring the indexes traversePTAG=usedPTAGinfo{2,1}{cntCPt} of placement points in the grid row corresponding to an component; acquiring X-coordinates traversePTX=PtArrayX{idxCpT, idxPtArray}(traversePTAG) of placement points in the corresponding grid row;
Step 532, acquiring, in traversePTX, the index [˜,idxNextPt]=min(abs(traversePTX−nextHdX)) of a placement point nearest to nextHdX in the grid row;
Step 533, determining whether cntHDs is greater than 1; if so, acquiring indexes idxLastPt=find(traversePTX<RecordX(idxlastX),1), less than RecordX(idxlastX), in traversePTX, and performing Step 543; otherwise, acquiring idxLastPt=find(traversePTX<CurrentX,1), and performing Step 534;
Step 534, determining whether idxLastPt is empty; if so, updating idxLastPt=numel(traversePTAG), and performing Step 535; otherwise, performing Step 535;
Step 535, acquiring a maximum selection range LimNextPt=min([idxLastPt+(idxHD−idxHD0)*mincyc, numel(traversePTAG)]) of the next placement point;
Step 536, determining whether idxNextPt>LimNextPt; if so, performing Step 537; otherwise, performing Step 538;
Step 537, determining whether LimNextPt<=0; if so, updating idxNextPt=1, and performing Step 538; otherwise, idxNextPt=LimNextPt, and performing Step 538;
Step 538, updating idxHD=idxHD0; updating CurrentX0=PtArrayX{idxCpT, idxPtArray}(traversePTAG(idxNextPt)); determining whether CurrentX0 is not empty; if so, performing Step 539; otherwise, performing Step 54; and
Step 539, updating CurrentX=CurrentX0, updatingSeqPTA{cntmc,idxHD0}=[idxCpT;idxPTAG;traversePTAG(idxNextPt)], and updating RecordX(cntHDs)=CurrentX;
removing assigned points usedPTAGinfo{2,1}{cntCPt}(idxNextPt)=[ ];
Step 54 comprising:
Step 541, determining whether sum(flagSC) is not 0; if so, updating the flag flagSC1=flagSC+flagSC0, wherein if flagSC1 is 1, it indicates that assignment of the current head has been completed, but assignment of “simultaneous placement” points has not been performed on the placement point; updating indexes with the flag flagSC1 of 1: idxHD_SC1=find(flagSC1==1); acquiring the number numHD_SC=numel(idxHD_SC1) of the indexes idxHD_SC1; initializing a head assignment count variable cntHD_SC=1; otherwise, performing Step 57;
Step 542, determining whether cntHD_SC<numHD_SC; if so, updating cntHDs=idxHD_SC1(cntHD_SC), updating flagSC0(cntHDs)=0, acquiringidxHD1=usedHDs(cntHDs), and performing Step 543; otherwise, performing Step 56;
Step 543, determining whether isempty(SeqPTA{cntmc,idxHD1}) is true; if so, updating cntHD_SC=cntHD_SC+1, and returning to Step 542; otherwise, acquiring cntCPt=tmpCPg(idxHD1); acquiring the component type index idxCpT=usedPTAGinfo{1,1}(1,cntCPt); acquiring idxPTinArray=SeqPTA{cntmc,idxHD1}(3); updating flagHD1st=0, and performing Step 544;
Step 544, determining whether STcounter{idxCpT,1}{1,1}(idxPTinArray) is not 0; if so, determining that simultaneous placement is available, and performing Step 545; otherwise, performing Step 55;
Step 545, acquiring co-Y-axis indexes idxSYMem=STcounter{idxCpT,1}{1,2}{idxPTinArray}(1,1), acquiring co-X-axis coordinate indexes idxSTXMem=STcounter{idxCpT,1}{1,2}{idxPTinArray}(1,2), acquiring indexes HD2PT=STMatchInfo{idxSYMem, 2}{idxSTXMem,1} of relative heads, acquiring the index Hds1st=STMatchInfo{idxSYMem, 2}{idxSTXMem,2} of a main head, initializing a main head count variable cntHds1st=1, and initializing a relative head count variable cntHds=1;
Step 546, determining whether cntHds1st<numHds1st; if so, performing Step 547; otherwise, performing Step 55;
Step 547, determining whether cntHds<numHdinMem; if so, performing Step 548; otherwise, performing Step 549;
Step 548, determining whether Hds1st(cntHds1st)+HD2PT(1,cntHds)−1 is equal to idxHD1 and HD2PT(2,cntHds) is equal to idxPTinArray; if so, updating HD1st=Hds1st(cntHds1st), updating flagHD1st=1, updating cntHds1st=cntHds1st+1, and returning to Step 546; otherwise, updating cntHds=cntHds+1, and returning to Step 547; and
Step 549, determining whether flagHD1st is not 0; if so, performing Step 55; otherwise, updating cntHds1st=cntHds1st+1, and returning to Step 546;
Step 55 comprising:
Step 551, determining whether flagHD1st is not 0; if so, initializing a “simultaneous placement” success flag STsuccess=0, initializing a temporary variable flagSTC1tmp=flagSTC1 of flagSTC1, initializing a temporary variable flagSCtmp=flagSC of flagSC, initializing a temporary variable ST_UHDtmp=ST_UHD of ST_UHD, and initializing the head count variable cntHds=1; otherwise, updating ST_UHD=cntHDs, updating cntHD_SC=cntHD_SC+1, and returning to Step 542;
Step 552, determining whether cntHds<numHdinMem; if so, updating idxHD0=HD1st+HD2PT(1,cntHds)−1, and performing Step 553; otherwise, performing Step 557;
Step 553, determining whether SeqPTA{cntmc,idxHD0} is empty; if so, updating idxCpT=HD2PT(4,cntHds), updating idxPTAG=HD2PT(3,cntHds), updating idxPTinArray=HD2PT(2,cntHds), updating cntCPt1=tmpCPg(idxHD0), acquiring, from usedPTAGinfo{2,1}{cntCPt1}, point indexes satisfying the condition idxPTleft=find(usedPTAGinfo{2,1}{cntCPt1}==idxPTinArray), and performing Step 554; otherwise, performing Step 555;
Step 554, determining whether idxPTleft is not empty; if so, updating SeqPTA{cntmc,idxHD0}=[idxCpT;idxPTAG;idxPTinArray], eliminating assigned placement point information usedPTAGinfo{2,1}{cntCPt1}(idxPTleft)=[ ], updating STsuccess=1, acquiring the position cntUHDs=find(usedHDs==idxHD0) of idxHD0 in a used head group, updating flagSC0(cntUHDs)=0, and performing Step 555;
Step 555, acquiring the position cntUHDs=ind(usedHDs==idxHD0) of idxHD0 in the used head group; determining whether cntUHDs is not 1; if so, updating flagSTC1tmp(cntUHDs)=1, and performing Step 556; otherwise, directly performing Step 556;
Step 556, updating ST_UHDtmp=[ST_UHDtmp cntUHDs]; updating flagSCtmp(cntUHDs)−0, updating cntHds=cntHds+1, and returning to Step 552; and
Step 557, determining whether STsuccess is not 0; if so, updating flagSTC1=flagSTC1tmp, updating flagSC=flagSCtmp, updatingST_UHD=ST_UHDtmp, and performing Step 558; otherwise, performing Step 558; and
Step 558, updating cntHds1st=cntHds1st+1, and returning to Step 546;
Step 56, determining subsequent points based on the progressive search rule:
Step 561, initializing the head count variable cntHDs=1;
Step 562, determining whether cntHDs<numHDs; if so, performing Step 563; otherwise, returning to Step 54;
Step 563, determining whether flagSC(cntHDs) is not 0; if so, performing Step 564; otherwise, updating cntHDs=cntHDs+1, and returning to Step 562;
Step 564, determining whether cntHDs>1 and flagSTC1(cntHDs−1) is not 0; if so, updating idxlastX=find(flagSTC1(1:(cntHDs−2))==0,1), and performing Step 565; otherwise, updating idxlastX=cntHDs−1, and performing Step 565; and
Step 565, performing Step 53 to determining groups of remaining points in the grid rows according to the progressive search rule, updating flagSC(cntHDs)=0, and returning to Step 54;
Step 57 comprising:
Step 571, acquiring heads that fail to realize simultaneous placement idxNotSTC=find(flagSTC1==0); acquiring components that fail to realize simultaneous tmpCPg1=tmpCPg(usedHDs(idxNotSTC)); acquiring placement SeqPTAtmp=SeqPTA(cntmc,:); determining whether tmpCPg1 is not empty; if so, performing Step 572; otherwise, performing Step 58;
Step 572, acquiring identical component indexes idxsame=find(tmpCPg1==tmpCPg1(1)); determining whether numel(idxsame)>1; if so, performing Step 573; otherwise, performing Step 576;
Step 573, acquiring heads corresponding to the same type of components that fail to realize simultaneous placement idxNSTC1=idxNotSTC(idxsame), sorting storage sites in RecordX [˜,idxsortRX]=sort(RecordX(idxNSTC1),‘descend’), acquiring corresponding head indexes idxUhd=usedHDs(idxNSTC1), and initializing a non-simultaneous placement count variable cntNSTC=1;
Step 574, determining whether cntNSTC<numel(idxsortRX); if so, performing Step 575; otherwise, performing Step 576;
Step 575, updating SeqPTA{cntmc,idxUhd(cntNSTC)}=SeqPTAtmp{1,idxUhd(idxsortRX(cntNSTC))}, updating cntNSTC=cntNSTC+1, and returning to Step 574; and
Step 576, eliminating assigned placement point information tmpCPg1(idxsame)=[ ], idxNotSTC(idxsame)=[ ], and returning to Step 571; and
Step 58, evaluating the movement time in the current cycle:
Step 581, initializing the indexes of heads that fail to realize simultaneous placement NoSTHDs=1:numHDs, NoSTHDs(ST_UHD)=[ ], and initializing the movement time TinCYC=0;
Step 582, initializing the head count variable cntHDs=1;
Step 583, determining whether cntHDs<numHDs1; if so, acquiring the head index idxHD=usedHDs1(cntHDs), and performing Step 584; otherwise, performing Step 585;
Step 584, determining whether SeqPTA{cntmc,idxHD} is not empty; if so, acquiringidxCpT=SeqPTA{cntmc,idxHD}(1), acquiring idxPTAG=SeqPTA{cntmc,idxHD}(2), acquiring idxPtArray=PTAGroup{idxCpT}{idxPTAG}(1,1), acquiring idxPTinArray=SeqPTA{cntmc,idxHD}(3), storing waypoints WaypointX(cntHDs)=PtArrayX{idxCpT, idxPtArray}(idxPTinArray)−(idxHD−1)*HDI corresponding to the heads, updating cntHDs=cntHDs+1, and returning to Step 583; otherwise, updating cntHDs=cntHDs+1, and returning to Step 583;
Step 585, sorting WaypointX:WaypointX=sort(WaypointX); acquiring the X-coordinate currentX=WaypointX(1) of the first placement point; initializing cntHDs=2;
Step 586, determining whether cntHDs<numHDs1; if so, performing Step 587; otherwise, performing Step 588;
Step 587, acquiring the X-coordinate nextX=WaypointX(cntHDs) of the next placement point; updating TinCYC=TinCYC+abs(currentX−nextX)/VX; updating currentX=nextX, and updating cntHDs=cntHDs+1; and
Step 588, returning usedPTAGinfo, SeqPTA, TinCYC, NoSTHD and ST_UHD;
wherein, Step 352 and Step 255 of Step 5 are invoked.

8. The time-optimal placement path optimization method for surface mounters according to claim 4, wherein the placement point assignment algorithm based on the simultaneous placement-maximized assignment rule comprises:
Step 61, initializing parameters, wherein the parameters include: grid row group usage information usedPTAGinfo, a corresponding temporary variable usedPTAGinfo1, finally processed grid row group information usedPTAGinfoB, the number of used heads numHDs=numel(usedHDs), heads capable of realize “simultaneous placement” ST_UHD=[ ] in usedHDs, a corresponding final result variable ST_UHDB, a final result variable SeqPTAB of SeqPTA, the number numPTinCpT=zeros(1,numCPTinCPg) of placement points corresponding to each component, and a flag flagFree=cell(1,numCPTinCPg) indicting whether each point is vacant;
Step 62, acquiring update parameter information:
Step 621, initializing a component count variable cntCPTinCPg=1;
Step 622, determining whether cntCPTinCPg<numCPTinCPg; if so, performing Step 623; otherwise, performing Step 624;
Step 623, updating numPTinCpT(cntCPTinCPg)=numel(usedPTAGinfo1{2,1}{cntCPTinCPg}); updating flagFree{cntCPTinCPg}=ones(1,numPTinCpT(cntCPTinCPg)); updating cntCPTinCPg=cntCPTinCPg+1, and returning to Step 622; and
Step 624, updating a maximum number of simultaneous placements numSTBest=0, updating the optimal movement time TinCycBest=inf, and updating flagPTinCpT=ones(1,numCPTinCPg), flagPTinCpT=ones(1,numCPTinCPg);
Step 63 comprising:
Step 631, determining whether flagPTinCpT(numCPTinCPg)<numPTinCpT(numCPTinCPg); if so, overloading a variable flagFree1=flagFree; usedPTAGinfo1=usedPTAGinfo; SeqPTA1=SeqPTA ST_UHD1=ST_UHD; flagSC=ones(numHD,1); flagSC(usedHDs)=flagSC(usedHDs)*0; flagPTinCpT1=flagPTinCpT; initializing WaypointX=zeros(1,numHDs); initializing TinCyc=0; initializing the head count variable cntHDs=1, and performing Step 632; otherwise, performing Step 69;
Step 632, determining whether cntHDs<=numHDs; if so, acquiring the head index idxHD1=usedHDs(cntHDs), and performing Step 633; otherwise, performing Step 68;
Step 633, determining whether flagSC(idxHD1) is 0; if so, performing Step 634; otherwise, updating cntHDs=cntHDs+1, and returning to Step 632;
Step 634, acquiring the component count variable cntCPt=tmpCPg(idxHD1), acquiring the component type index idxCpT=usedPTAGinfo1{1,1}(1,cntCPt), and acquiring the number numPTmp=numel(usedPTAGinfo1{2,1}{cntCPt}) of remaining points in grid rows corresponding to the current type of components;
Step 635, determining whether numPTmp is 0; if so, updating cntHDs=cntHDs+1, and returning to Step 632; otherwise, performing Step 636; and
Step 636, acquiring a rightmost placement point MostRightPT=min([flagPTinCpT1(cntCPt) numPTmp]) corresponding to the current component, acquiring indexes idxnon0-find(WaypointX>0) of non-zero points in WaypointX, acquiring the number numnon0-numel(idxnon0) of elements in idxnon0, initializing a time storage array WPXTime=zeros(1,numnon0), acquiring coordinates WPX1=WaypointX(idxnon0) of the non-zero points, initializing a simultaneous point exist flag flagHD1st=0, initializing the optimal movement time minWPXTBest=100, and initializing the optimal first head HD1stBest=0;
Step 64, determining whether flagHD1st is 0; if so, performing Step 641; otherwise, performing Step 66;
Step 641, determining whether flagFree1{cntCPt}(MostRightPT) is 1; if so, performing Step 642; otherwise, performing Step 659;
Step 642, acquiring a point index idxPTinArray1=usedPTAGinfo1{2,1}{cntCPt}(MostRightPT) of the point MostRightPT in the grid row;
Step 643, determining whether there is ideal simultaneous placement isempty(STcounter{idxCpT,1}{1,2}{idxPTinArray1}) for the point; if so, performing Step 644; otherwise, performing Step 66;
Step 644, acquiring a Y-direction simultaneous placement index idxSYMem=STcounter{idxCpT,1}{1,2}{idxPTinArray1}(1,1), acquiring an X-direction simultaneous placement index idxSTXMem=STcounter{idxCpT,1}{1,2}{idxPTinArray1}(1,2), acquiring indexes HD2PT=STMatchInfo{idxSYMem,2}{idxSTXMem,1} of heads corresponding to simultaneous placement points, acquiring the number numHds1st=numel(Hds1st) of main heads, and acquiring the number numHdinMem=size(HD2PT,2) of HD2PT;
Step 645, initializing a main head count variable cntHds1st=1;
Step 646, determining whether cntHds1st<numHds1st; if so, performing Step 647; otherwise, performing Step 658;
Step 647, acquiring head indexes idxHds=Hds1st(cntHds1st)+HD2PT(1,:)−1 of simultaneous placement groups corresponding to the main heads; and
Step 648, determining whether all heads in idxHds have been assigned; if so, updating cntHds1st=cntHds1st+1, and returning to Step 646; otherwise, performing Step 65;
Step 65 comprising:
Step 651, initializing the head count variable cntHds=1; determining whether cntHds<numHdinMem; if so, performing Step 652; otherwise, performing Step 657;
Step 652, determining whether Hds1st(cntHds1st)+HD2PT(1,cntHds)−1 is equal to idxHD1 and HD2PT(2,cntHds)==idxPTinArray1; if so, performing Step 653; otherwise, updating cntHds=cntHds+1, and returning to Step 651;
Step 653, acquiring indexes HD1st0=Hds1st(cntHds1st) of the main heads; determining whether idxnon0 is empty; if so, updating HD1stBest=HD1st0, updating flagHD1st=1, updating idxSYMemBest-idxSYMem, updating idxSTXMemBest=idxSTXMem, and performing Step 657; otherwise, performing Step 654;
Step 654, acquiringidxCpT=HD2PT(4,cntHds), acquiring idxPTAG-HD2PT(3,cntHds), acquiringidxPtArray=PTAGroup{idxCpT}{idxPTAG}(1,1), acquiringidxPTinArray2=HD2PT(2,cntHds), acquiringidxHD0=HD1st0+HD2PT(1,cntHds)−1, transforming placement point coordinates to corresponding placement points WPXtmp=PtArrayX{idxCpT, idxPtArray}(idxPTinArray2)−(idxHD0-1)*HDI, and initializing a non-zero placement point count variable cntnon0=1;
Step 655, determining whether cntnon0<numnon0; if so, updating WPXTime(cntnon0)=abs(WPXtmp−WPX1(cntnon0))/VX, updating cntnon0=cntnon0+1, and returning to Step 655; otherwise, performing Step 656;
Step 656, acquiring a minimum time minWPXTime=min(WPXTime); determining whether minWPXTBest>minWPXTime; if so, updating minWPXTBest=minWPXTime, updatingHD1stBest=HD1st0, updating idxSYMemBest=idxSYMem, updating idxSTXMemBest=idxSTXMem, and performing Step 657; otherwise, performing Step 657;
Step 657, determining whether flagHD1st is not 0; if so, performing Step 658; otherwise, cntHds1st=cntHds1st+1, and returning to Step 646;
Step 658, determining whether flagHD1st is not 0; if so, performing Step 66; otherwise, performing Step 659; and
Step 659, updating MostRightPT=MostRightPT+1; determining whether MostRightPT>numPTmp; if so, determining that all points fail to realize simultaneous placement, and performing Step 66; otherwise, returning to Step 64;
Step 66 comprising:
Step 661, determining whether flagHD1st is not 0; if so, updating HD2PT=STMatchInfo{idxSYMemBest, 2}{idxSTXMemBest,1}; initializing the “simultaneous placement” success flag STsuccess=0, initializing the temporary variable ST_UHDtmp=ST_UHD1 of heads capable of realizing simultaneous placement, initializing the temporary variable WaypointX1=WaypointX of WaypointX, initializing a head assignment flag initializing SeqPTA2=SeqPTA1, initializing flagSC1=flagSC, usedPTAGinfo2=usedPTAGinfo1, initializing flagFree2=flagFree1, initializing cntST=0, acquiring the number numHdinMem=size(HD2PT,2) of elements in HD2PT,initializing the head count variable cntHds=1, and performing Step 662; otherwise, updating cntHDs=cntHDs+1, and returning to Step 632;
Step 662, determining whether cntHds<numHdinMem; if so, performing Step 663; otherwise, performing Step 668;
Step 663, acquiring the head index idxHD0=HD1stBest+HD2PT(1,cntHds)−1; determining whether SeqPTA2{cntmc,idxHD0} is empty; if so, acquiring idxCpT=HD2PT(4,cntHds), acquiringidxPTAG=HD2PT(3,cntHds), acquiring idxPtArray=PTAGroup{idxCpT}{idxPTAG}(1,1), acquiring idxPTinArray2=HD2PT(2,cntHds), acquiring cntCPt1=tmpCPg(idxHD0), acquiring the position idxPTleft=find(usedPTAGinfo2{2,1}{cntCPt1}==idxPTinArray2) of idxPTinArray2 in remaining grid rows, and performing Step 664; otherwise, updating cntHds=cntHds+1, and returning to Step 662;
Step 664, determining whether the current placement point has been assigned, that is, whether flagFree2{cntCPt1}(idxPTleft) is empty; if so, updating cntHds=cntHds+1, and returning to Step 662; otherwise, performing Step 665;
Step 665, determining whether idxPTleft is empty; if so, updating cntST=cntST+1, and performing Step 666; otherwise, updating cntHds=cntHds+1, and returning to Step 662;
Step 666, determining whether cntST>1; if so, updating STsuccess=1; otherwise, performing Step 667;
Step 667, updating SeqPTA2{cntmc,idxHD0}=[idxCpT;idxPTAG;idxPTinArray2]; eliminating assigned placement points usedPTAGinfo2{2, 1}{cntCPt1}(idxPTleft)=[ ]; updating flagFree2{cntCPt1}(idxPTinArray2)=0; acquiring the position cntUHDs=find(usedHDs==idxHD0) of idxHD0 in the used head group; updating ST_UHDtmp=[ST_UHDtmp cntUHDs]; updating flagSC1(idxHD0)=1; updating WaypointX1(idxHD0)=PtArrayX{idxCpT, idxPtArray}(idxPTinArray2)−(idxHD0-1)*HDI; updating cntHds=cntHds+1, and returning to Step 662;
Step 668, determining whether STsuccess is not 0; if so, updating cntHDs=cntHDs+1, updating TinCyc=TinCyc+minWPXTBest, updating ST_UHD1=ST_UHDtmp, updating WaypointX=WaypointX1, updating flagSC=flagSC1, updating SeqPTA1=SeqPTA2, updating usedPTAGinfo1=usedPTAGinfo2, updating flagFree1=flagFree2, and returning to Step 632; otherwise, performing Step 669; and
Step 669, updating flagPTinCpT1(cntCPt)=flagPTinCpT1(cntCPt)+1; determining whether flagPTinCpT1(cntCPt)>numPTinCpT(cntCPt); if so, updating cntHDs=cntHDs+1, updating flagPTinCpT1=flagPTinCpT, and returning to Step 632; otherwise, returning to Step 632; and
Step 67, updating a current optimal assignment result:
Step 671, acquiring the number numST1=numel(ST_UHD1) of heads capable of realizing simultaneous placement;
Step 672, determining whether numSTBest<numST1, or numSTBest==numST1 and TinCyc<TinCycBest; if so, performing Step 673; otherwise, performing Step 674;
Step 673, updating numSTBest=numST1, updating TinCycBest=TinCyc, updating usedPTAGinfoB-usedPTAGinfo1, updating SeqPTAB=SeqPTA1, and updating ST_UHDB=ST_UHD1;
Step 674, updating flagPTinCpT(1)=flagPTinCpT(1)+1, and initializing the component count variable cntCPTinCPg=2;
Step 675, determining whether cntCPTinCPg<numCPTinCPg; if so, performing Step 676; otherwise, returning to Step 63;
Step 676, determining whether flagPTinCpT(cntCPTinCPg−1)>numPTinCpT(cntCPTinCPg−1); if so, performing Step 677; otherwise, returning to Step 63;
Step 677, updating flagPTinCpT(cntCPTinCPg)=flagPTinCpT(cntCPTinCPg)+1, and updating flagPTinCpT(cntCPTinCPg−1)=1; and
Step 68, updating returned values usedPTAGinfo=usedPTAGinfoB, SeqPTA=SeqPTAB, ST_UHD=ST_UHDB, and returning to Step 255.

9. The time-optimal placement path optimization method for surface mounters according to claim 4, wherein a process of completing placement point assignment of remaining heads by means of the nearest insertion method comprises:
Step 71, initializing parameters, wherein the parameters include: a first assignment cycle cycfirst=CPg1stCyc(cntCPg), a last assignment cycle cyclast=min([cyclast, ceilCycle(cntCPg)]), the number tmpNumPT=numPTinCpT of placement points corresponding to components, corresponding X-coordinates, Y-coordinates and serial numbers of placement pointsCpTX2=CpTX0, CpTY2=CpTY0, CpNo2=CpNo0, and an intermediate variable tmpOCP-OrderCp of the component allocation result;
Step 72, updating a grid row assignment result into tmpOCP, and eliminating information of assigned grid rows:
Step 721, initializing the component type count variable cntCpT=1;
Step 722, determining whether cntCpT<numCPT_JL; if so, performing Step 723;
otherwise, performing Step 73;
Step 723, acquiring idxCpT=CPT_JL(cntCpT), acquiring the head index idxHds=Head2CPT0{idxCpT,1}, updating tmpOCP(cycfirst:cyclast,idxHds)=preOCP(cycfirst:cyclast,idxHds), and initializing the cycle count variable cntcyc=cycfirst;
Step 724, determining whether cntcyc<cyclast; if so, initializing the head count variable cnts=1, and performing Step 725; otherwise, updating cntCpT=cntCpT+1, and returning to Step 722;
Step 725, determining whether cnts<numHds; if so, performing Step 726; otherwise, cntcyc=cntcyc+1, returning to Step 724;
Step 726, acquiring the head index idxHd=idxHds (cnts), acquiring indexes idxDeleteCp-find(CpNo2{idxCpT}==preOCP(cntcyc,idxHd),1) of placement points that need to be deleted;
Step 727, determining whether idxDeleteCp is not empty; if so, performing Step 728; otherwise, cnts=cnts+1, returning to Step 725; and
Step 728, eliminating assigned placement point information CpTY2{idxCpT}(idxDeleteCp)=[ ], CpTX2{idxCpT}(idxDeleteCp)=[ ], CpNo2{idxCpT}(idxDeleteCp)=[ ]; updating the number tmpNumPT(idxCpT)=tmpNumPT(idxCpT)−1 of components; updating cnts=cnts+1, and returning to Step 725;
Step 73, updating indexes unsureS=find(CPg(cntCPg,:)˜=0) of to-be-assigned heads corresponding to a new component group and the number numUsS=numel(unsureS) of the to-be-assigned heads;
Step 74, initializing the cycle count variable cntcyc=cycfirst;
Step 75, determining whether cntcyc<cyclast; if so, performing Step 67; otherwise, completing matching of remaining non-assigned placement points, and returning to Step 28;
Step 76, initializing a temporary variable unsureS0=unsureS; searching tmpOCP for indexes idxsureS=find(tmpOCP(cntcyc,unsureS0)>0) of assigned heads; acquiring confirmed heads sureS0=unsureS (idxsureS), and acquiring the number numsS0=numel(sureS0) of the confirmed heads; deleting the confirmed heads unsureS0(idxsureS)=[ ]; acquiring the number numUnS=numel(unsureS0) of non-confirmed heads;
Step 77, determining whether numUnS is 0; if so, updating cntcyc=cntcyc+1, and returning to Step 75; otherwise, performing Step 78; and
Step 78, assigning non-assigned heads by means of the nearest insertion method, updating cntcyc=cntcyc+1, and returning to Step 75.

10. A time-optimal placement path optimization device for surface mounters, comprising a storage device, a processor, and a computer program stored in the storage device and executable on the processor, wherein the processor executes the computer program to implement the time-optimal placement path optimization method for surface mounters according to claim 4.
